(19) United States
(12) Patent Application Publication
(10) Pub. No.: US 2020/0376874 A1
(43) Pub. Date: Dec. 3, 2020

(54) ELECTROSTATICALLY ASSISTED PRINTING OF A PACKAGING MATERIAL LAMINATE FOR DIMENSIONALLY STABLE FOOD AND DRINK PRODUCT CONTAINERS WITH A MULTITUDE OF PRINTING UNITS

(71) Applicant: SIG TECHNOLOGY AG, Neuhausen am Rheinfall (CH)

(72) Inventors: Dirk SCHIBULL, Hückelhoven Baal (DE); Ulrich LEMME, Bedburg (DE); Peter GREGOR, Saalfelden (AT)

(21) Appl. No.: 16/305,706

(22) PCT Filed: May 23, 2017
(86) PCT No.: PCT/EP2017/062444

§ 371 Date: Nov. 29, 2018

(30) Foreign Application Priority Data
May 30, 2016 (DE) 102016209350.9

(51) Int. Cl. B41M 1/10; B32B 27/10; B65D 65/40; B65D 65/42

(52) U.S. Cl. CPC B41M 1/10; B32B 27/10; B65D 65/40; B65D 65/42; B32B 2255/12; B32B 2439/70; B32B 2307/206; B32B 2307/4023; B32B 2307/7242; B32B 2307/75; B32B 2439/40; B32B 2255/10

(57) ABSTRACT

The invention relates to a method (100) comprising, as method steps, a) providing i) a sheetlike composite (300) comprising, as mutually superposed layers, A) a carrier layer (303), B) a barrier layer (305), and C) an inner polymer layer (306), ii) n components (603, 605, 607), where, for every i from 1 to n, A) the ith component (603, 605, 607) comprises an ith component surface (801), and B) the ith component surface (801) comprises a multitude of recesses (802), wherein the recesses (802) each comprise a composition (803) comprising a colourant, wherein then components (603, 605, 607) rotate in one method direction, wherein, for every i from 1 to (n−1), the (i+1)th component (603, 605, 607) is arranged after the ith component (603, 605, 607) in the method direction; and b) moving the sheetlike composite (300), such that a first region of the sheetlike composite (300) runs through the following sequence of steps comprising steps b) i) (103, 105) and b) ii) (104, 106) successively for every i from 1 to n in ascending sequence: i) altering an electrical voltage between the first region and the ith component surface (801), and
ii) contacting an outer surface (301) of the sheetlike composite (300) in the first region with the ith component surface (801);
where n is a natural number and is at least 2, where i is a natural number. The invention further relates to an apparatus (600), to a printed sheetlike composite (400), to a container precursor (900) and to a closed container (1000).

The invention relates to methods comprising, as method steps,
a) providing
   i) a sheetlike composite comprising, as mutually superposed layers, from an outer surface of the sheetlike composite to an inner surface of the sheetlike composite,
      A) a carrier layer,
      B) a barrier layer, and
      C) an inner polymer layer,
   ii) n components, where, for every i from 1 to n,
      A) the ith component comprises an ith component surface, and
      B) the ith component surface comprises a multitude of recesses,
      wherein the recesses each comprise a composition comprising a colourant,
      wherein the n components rotate in one method direction,
      wherein, for every i from 1 to (n−1), the (i+1)th component is arranged after the ith component in the method direction; and
b) moving the sheetlike composite, such that a first region of the sheetlike composite runs through the following sequence of steps comprising steps b) i) and b) ii) successively for every i from 1 to n in ascending sequence:
   i) altering an electrical voltage between the first region and the ith component surface, and
   ii) contacting the outer surface of the sheetlike composite in the first region with the ith component surface;

where n is a natural number and is at least 2, where i is a natural number. The invention further relates to an apparatus, to a printed sheetlike composite, to a container precursor and to a closed container.

For a long time, food and drink products, whether they be food and drink products for human consumption or else animal feed products, have been preserved by storing them either in a can or in a jar closed by a lid. In this case, shelf life can be increased firstly by separately and as much as possible sterilizing the food or drink product and the container in each case, here the jar or can, and then introducing the food or drink product into the container and closing the container. However, these measures of increasing the shelf life of food and drink products, which have been tried and tested over a long period, have a series of disadvantages, for example the need for another sterilization later on. Cans and jars, because of their essentially cylindrical shape, have the disadvantage that very dense and space-saving storage is not possible. Moreover, cans and jars have considerable intrinsic weight, which leads to increased energy expenditure in transport. In addition, production of glass, tinplate or aluminium, even when the raw materials used for the purpose are recycled, necessitates quite a high expenditure of energy. In the case of jars, an additional aggravating factor is elevated expenditure on transport. The jars are usually prefabricated in a glass factory and then have to be transported to the facility where the food and drink products are dispensed with utilization of considerable transport volumes. Furthermore, jars and cans can be opened only with considerable expenditure of force or with the aid of tools and hence in a rather laborious manner. In the case of cans, there is a high risk of injury emanating from sharp edges that arise on opening. In the case of jars, it is a regular occurrence that broken glass gets into the food or drink product in the course of filling or opening of the filled jars, which can lead in the worst case to internal injuries on consumption of the food or drink product. In addition, both cans and jars have to be labelled for identification and promotion of the food or drink product contents. The jars and cans cannot readily be printed directly with information and promotional messages. In addition to the actual printing, a substrate is thus needed for the purpose, a paper or suitable film, as is a securing means, an adhesive or sealant.

Other packaging systems are known from the prior art, in order to store food and drink products over a long period with minimum impairment. These are containers produced from sheetlike composites—frequently also referred to as laminates. Sheetlike composites of this kind are frequently constructed from a thermoplastic plastic layer, a carrier layer usually consisting of paperboard or paper which imparts dimensional stability to the container, an adhesion promoter layer, a barrier layer and a further plastic layer, as disclosed inter alia in WO 90/09926 A2. Since the carrier layer imparts dimensional stability to the container manufactured from the laminate, these containers, by contrast with film bags, can be regarded as a further development of the aforementioned jars and cans.

Typically, the above-described containers are provided with printed decoration on the outside. This allows the consumer of the food or drink product within the container to be provided with relevant information, for example ingredients of the food or drink product, directly on the container. In addition, the decoration serves for promotional purposes and for the configuration of a pleasing product appearance. In the prior art, the decoration is applied to the laminate by an intaglio printing method prior to the folding of the laminate. For this purpose, a print roll having a multitude of recesses, called cells, is used. The cells are filled with a printing ink which, when pressed onto the outer face of the laminate to be printed, is absorbed by the laminate. Thus, the cells of the print roll correspond to the individual pixels of the printed decoration. In order to achieve a print of maximum quality, sufficient printing ink has to be applied to the laminate from every cell if at all possible. If too little printing ink, if any, is absorbed by the laminate from a cell, this pixel will be missing from the print. This is also referred to as missing dots. For an acceptable print, only a maximum proportion of missing dots is tolerable. The rougher the laminate surface to be printed, for example a surface of a paperboard layer, the more missing dots will generally arise on printing. The absorption of the printing ink by the laminate is made more difficult in that the liquid printing ink in the cell forms a meniscus. The surface level of the printing ink in the cell is accordingly concave, meaning that it curves away from the laminate. As a result, only laminate surfaces that do not exceed a certain roughness can be satisfactorily printed. The surface roughness of the laminate is determined to a crucial degree by the paperboard layer. Thus, the paperboard layer has to be modified in a usually complex manner, in order to obtain a relatively smooth surface of the laminate having good printability. For this purpose, the paperboard layer is provided, for example, with one or more paper coating layers. This leads to considerable additional costs in the container production. Moreover, the above-described decorations are typically multicoloured. The various colours are typically applied by various successive printing units. Thus, each colour corresponds to a separate ink application. A particular technical challenge is that of applying each colour of the decoration with a minimum number of missing dots. In this context too, the paperboard layer should ideally have to be modified to a minimum degree in order to assure good print quality. A further technical challenge arises from the achievability of the aforementioned multicoloured decorations of maximum print quality, while the speed with which the laminate web is guided through the printing units has to be variable. A variable web speed is required since the printing of the decoration first has to be preceded by colour matching of the printing units and, moreover, various decorations permit and require different printing speeds.

Thus, laminate containers produced from the aforementioned packaging systems have many advantages over the conventional jars and cans. There are nevertheless opportunities for improvement in the case of these packaging systems too, especially in the printing thereof with decorations.

In general terms, it is an object of the present invention to at least partly overcome a disadvantage that arises from the prior art. It is a further object of the invention to provide a dimensionally stable food or drink product container made from a packaging material laminate with a decoration having an improved multicoloured print. It is a further object of the present invention to provide a dimensionally stable food or drink product container made from a packaging material laminate with a multicoloured decoration, wherein the multicoloured decoration has an equally good or improved print on a rougher printed surface. It is a further object of the invention to provide a dimensionally stable food or drink product container made from a packaging material laminate with a multicoloured decoration, wherein the multicoloured decoration has been printed directly onto a paperboard or paper layer of the packaging material laminate. It is a further object of the invention to provide a dimensionally stable food or drink product container made from a packaging material laminate with a multicoloured decoration, wherein the multicoloured decoration has a lower weight per unit area for the same area coverage. It is a further object of the invention to provide a dimensionally stable food or drink product container made from a packaging material laminate with a multicoloured decoration, wherein the multicoloured decoration has a broader spectrum of an area coverage. It is a further object of the invention to provide a dimensionally stable food or drink product container made from a packaging material laminate with a multicoloured decoration, wherein the food or drink product container is producible at lower cost. It is a further object of the invention to provide a dimensionally stable food or drink product container having one of the above advantages, wherein the multicoloured decoration has been obtained by intaglio printing. It is a further object of the invention to provide one of the above advantageous dimensionally stable food or drink product containers made from a packaging material laminate, wherein the packaging material laminate comprises an electrically conductive barrier layer, preferably of aluminium.

It is another object of the invention to provide a printing method, preferably an intaglio printing method, and an apparatus for the purpose, with which the above packaging material laminate for dimensionally stable food and drink product containers can be printed with one of the aforementioned multicoloured decorations. It is a further object of the invention to provide the above method and the above apparatus, wherein both permit a change in the printing speed with a minimum level of complexity. It is additionally an object of the invention to provide the above method, wherein residues of ink solvents on the laminate are reduced. It is also an object of the invention to provide the above process, wherein the ink drying time is reduced with the same drying power. It is another object of the invention for the aforementioned method to be performable with maximum safety, especially with regard to safety at work. An aforementioned multicoloured decoration preferably comprises at least 4, more preferably at least 6, printed colour screens of different colours. Particular preference is given here to exactly 5 or 6 printed colour screens of different colours.

A contribution to the at least partial achievement of at least one of the aforementioned objects is made by the independent claims. The dependent claims provide preferred embodiments which contribute to the at least partial achievement of at least one of the objects.

In the present description, specified ranges also include the values mentioned as limits. A statement of the kind “in the range from X to Y” in relation to a parameter A consequently means that A can assume the values of X, Y and values between X and Y. Ranges limited at one end of the kind “up to Y” for a parameter A correspondingly mean, as values, Y and less than Y.

A contribution to the achievement of at least one of the objects of the invention is made by an embodiment 1 of a method 1 comprising, as method steps,
a) providing
   i) a sheetlike composite comprising, as mutually superposed layers, from an outer surface of the sheetlike composite to an inner surface of the sheetlike composite,
      A) a carrier layer,
      B) a barrier layer, and
      C) an inner polymer layer,
   ii) n components, where, for every i from 1 to n,
      A) the ith component comprises an ith component surface, and
      B) the ith component surface comprises a multitude of recesses,
      wherein the recesses each comprise a composition comprising a colourant,
      wherein the n components rotate in one method direction,
      wherein, for every i from 1 to (n−1), the (i+1)th component is arranged after the ith component in the method direction; and
b) moving the sheetlike composite, such that a first region of the sheetlike composite runs through the following sequence of steps comprising steps b) i) and b) ii) successively for every i from 1 to n in ascending sequence:
   i) altering an electrical voltage between the first region and the ith component surface, and
   ii) contacting the outer surface of the sheetlike composite in the first region with the ith component surface;

where n is a natural number and is at least 2, where i is a natural number. Preferably, n is at least 3, more preferably at least 4, more preferably at least 5, even more preferably at least 6. More preferably, n is exactly 5 or 6. In some configurations of the invention, n may also be 10 or greater than 10.

In one embodiment 2 of the invention, the method 1 is configured according to embodiment 1, wherein, for every i from 1 to n in method step b) i), the altering of the electrical voltage between the first region and the ith component surface is an increase in an absolute value of the electrical voltage.

In one embodiment 3 of the invention, the method 1 is configured according to embodiment 2, wherein, for every i from 1 to n in method step b) i), the increase in the absolute value of the electrical voltage is to an absolute value in a range from 200 to 1500 V, preferably from 300 to 1300 V, more preferably from 400 to 1100 V, more preferably from 500 to 1000 V, most preferably from 600 to 900 V.

In one embodiment 4 of the invention, the method 1 is configured according to any of the preceding embodiments, wherein, for every odd i, the altering of the electrical voltage in method step b) i) is in the opposite sense to the altering of the electrical voltage for every even i in method step b) i). In a preferred configuration of the invention, the electrical voltage becomes more negative for every odd i and more positive for every even i. In a further preferred configuration of the invention, the electrical voltage becomes more positive for every odd i and more negative for every even i.

In one embodiment 5 of the invention, the method 1 is configured according to any of the preceding embodiments, wherein, in method step a), n electrodes are further provided; wherein, for every i from 1 to n,
a. the ith electrode is arranged and designed for exchange of electrical charge carriers with the outer surface of the sheetlike composite, and
b. the ith electrode is arranged before the ith component looking downstream;

wherein, for every i in method step b) i), an ith charge voltage is applied to the ith electrode, wherein an absolute value of the ith charge voltage for every odd i is different from an absolute value of the ith charge voltage for every even i by less than 500 V, preferably by less than 300 V, more preferably by less than 200 V, even more preferably by less than 100 and most preferably by less than 50 V. A value of the ith charge voltage is based here on earth potential.

In one embodiment 6 of the invention, the method 1 is configured according to any of embodiments 1 to 4, wherein, in method step a), n electrodes are further provided; wherein, for every i from 1 to n,
a. the ith electrode is arranged and designed for exchange of electrical charge carriers with the outer surface of the sheetlike composite, and
b. the ith electrode is arranged before the ith component looking downstream;

wherein, for every i in method step b) i), an ith charge voltage is applied to the ith electrode, wherein, for at least one i in a range from 1 to n−1, an absolute value of the ith charge voltage is different from an absolute value of the (i+1)th charge voltage by more than 100 V, preferably by more than 150 V, more preferably by more than 200 V. A value of the ith charge voltage is based here on earth potential.

In one embodiment 7 of the invention, the method 1 is configured according to any of the preceding embodiments, wherein the moving of the sheetlike composite in method step b) is at a composite speed, wherein the method comprises, as further method steps,
c) changing the composite speed by at least 50 m/min, preferably by at least 70 m/min, more preferably by at least 100 m/min, most preferably by at least 200 m/min, and
d) moving the sheetlike composite at the composite speed such that a further region of the sheetlike composite runs through the following sequence of steps comprising steps d) i) and d) ii) successively for every i from 1 to n in ascending sequence:
   i) altering an electrical voltage between the further region and the ith component surface, and
   ii) contacting the outer surface of the sheetlike composite in the further region with the ith component surface.

In one embodiment 8 of the invention, the method 1 is configured according to any of the preceding embodiments, wherein the contacting of the outer surface of the sheetlike composite in the first region with the nth component surface is followed by a decrease in the value of an electrical charge in the region.

In one embodiment 9 of the invention, the method 1 is configured according to embodiment 8, wherein, in method step a), an (n+1)th electrode is further provided; wherein the (n+1)th electrode
a. is arranged and designed for exchange of electrical charge carriers with the outer surface of the sheetlike composite, and
b. is arranged after the nth component looking downstream;

wherein, when i =n, after method step b) ii) a discharge voltage in a range from 50 to 500 V, preferably from 100 to 400 V, more preferably from 120 to 300 V, is applied to the (n+1)th electrode. A value of the discharge voltage is based here on earth potential.

In one embodiment 10 of the invention, the method 1 is configured according to any of the preceding embodiments, wherein, in method step b), a voltage of the barrier layer versus earth is always in a range from −50 and +50 V, preferably from −40 to +40 V, more preferably from −30 to +30 V, most preferably from −20 to +20 V.

In one embodiment 11 of the invention, the method 1 is configured according to any of the preceding embodiments, wherein the n components are each earthed.

In one embodiment 12 of the invention, the method 1 is configured according to any of the preceding embodiments, wherein the barrier layer is electrically conductive.

In one embodiment 13 of the invention, the method 1 is configured according to any of the preceding embodiments, wherein the barrier layer comprises a metal or a metal oxide or both and in each case preferably consists thereof. A preferred metal is aluminium.

In one embodiment 14 of the invention, the method 1 is configured according to any of the embodiments 1 to 11, wherein the barrier layer is electrically insulating. The barrier layer preferably does not comprise any metal foil or any metal film or either.

In one embodiment 15 of the invention, the method 1 is configured according to any of the preceding embodiments, wherein, for every i from 1 to n, in method step b) ii), the sheetlike composite is contacted with an ith further component, the ith further component rotating in the opposite sense from the ith component. Preferably, for every i from 1 to n, the ith further component is earthed.

In one embodiment 16 of the invention, the method 1 is configured according to any of the preceding embodiments, wherein, for every i from 1 to n in method step b) i), the voltage is altered by contacting the outer surface of the sheetlike composite in the region with an ith electrode.

In one embodiment 17 of the invention, the method 1 is configured according to any of the preceding embodiments, wherein the sheetlike composite is characterized by an ignition residue determined by the method described herein in a range from 0.1 to 75 mg, preferably from 0.2 to 50 mg, more preferably from 0.3 to 30 mg, most preferably from 0.3 to 25 mg.

In one embodiment 18 of the invention, the method 1 is configured according to any of the preceding embodiments, wherein the sheetlike composite further comprises, on a side of the carrier layer facing the outer surface, an outer polymer layer, wherein the outer polymer layer has a layer thickness in a range from 1 to 30 μm, preferably from 2 to 25 μm, more preferably from 3 to 20 μm, most preferably from 3 to 10 μm.

In one embodiment 19 of the invention, the method 1 is configured according to any of the preceding embodiments, wherein, for every i from 1 to n, in method step b) ii), the sheetlike composite is overlaid by an ith colour application on the outer surface, wherein every ith colour application is characterized by a number of missing dots in a range from 0 to 100, preferably from 0 to 70, more preferably from 0 to 60, more preferably from 0 to 40, more preferably from 0 to 30, more preferably from 0 to 20, more preferably from 0 to 10, most preferably from 0 to 8, in each case per 100 mm².

In one embodiment 20 of the invention, the method 1 is configured according to any of the preceding embodiments, wherein, for every i from 1 to n, in method step b) ii), the sheetlike composite is printed by intaglio printing.

In one embodiment 21 of the invention, the method 1 is configured according to any of the preceding embodiments, wherein, for at least one i from 1 to n, in method step b) ii), the sheetlike composite is overlaid by a colour application on the outer surface, wherein the colour application comprises a first colour application region and a further colour application region, wherein the first colour application region is characterized by an area coverage of at least 50%, preferably of at least 60%, more preferably of at least 70%, more preferably of at least 80%, most preferably of at least 90%, wherein the further colour application region is characterized by an area coverage in a range from more than 0% up to 15%, preferably from more than 0% up to 13%, more preferably from more than 0% up to 11%, more preferably from more than 0% up to 9%, most preferably from more than 0% up to 5%, wherein the first colour application region adjoins the further colour application region. The aforementioned degrees of area coverage preferably relate to the same colour.

In one embodiment 22 of the invention, the method 1 is configured according to any of the preceding embodiments, wherein the outer surface is a surface of the carrier layer.

In one embodiment 23 of the invention, the method 1 is configured according to any of the preceding embodiments, wherein the inner polymer layer comprises a polymer prepared by means of a metallocene catalyst to an extent of 10% to 90% by weight, preferably to an extent of 25% to 90% by weight, more preferably to an extent of 30% to 80% by weight, based in each case on the total weight of the inner polymer layer.

In one embodiment 24 of the invention, the method 1 is configured according to any of the preceding embodiments, wherein the inner polymer layer comprises a polymer blend, wherein the polymer blend comprises an mPE to an extent of 10% to 90% by weight, preferably to an extent of 25% to 90% by weight, more preferably to an extent of 30% to 80% by weight, and a further polymer to an extent of at least 10% by weight, preferably to an extent of at least 15% by weight, more preferably to an extent of at least 20% by weight, based in each case on the total weight of the polymer blend.

In one embodiment 25 of the invention, the method 1 is configured according to any of the preceding embodiments, wherein the carrier layer is one selected from the group consisting of cardboard, paperboard and paper, or a combination of at least two thereof, and preferably consists thereof.

In one embodiment 26 of the invention, the method 1 is configured according to any of the preceding embodiments, wherein the carrier layer has at least one hole, wherein the hole is covered at least by the barrier layer and at least by the inner polymer layer as hole-covering layers.

In one embodiment 27 of the invention, the method 1 is configured according to any of the preceding embodiments, wherein the outer surface is not comprised by a cover layer of the carrier layer.

A contribution to the achievement of at least one of the objects of the invention is made by an embodiment 1 of a printed sheetlike composite 1, obtainable by the method 1 according to any of its embodiments 1 to 27.

In one embodiment 2 of the invention, the printed sheetlike composite 1 is configured according to embodiment 1, wherein the outer surface of the printed sheetlike composite is overlaid by a colour application, wherein the colour application is characterized by a number of missing dots in a range from 0 to 100, preferably from 0 to 70, more preferably from 0 to 60, more preferably from 0 to 40, more preferably from 0 to 30, more preferably from 0 to 20, more preferably from 0 to 10, most preferably from 0 to 8, in each case per 100 mm².

In one embodiment 3 of the invention, the printed sheetlike composite 1 is configured according to embodiment 2, wherein the colour application comprises a first colour application region and a further colour application region, wherein the first colour application region is characterized by an area coverage of at least 50%, preferably of at least 60%, more preferably of at least 70%, more preferably of at least 80%, most preferably of at least 90%, wherein the further colour application region is characterized by an area coverage in a range from more than 0% up to 15%, preferably from more than 0% up to 13%, more preferably from more than 0% up to 11%, more preferably from more than 0% up to 9%, most preferably from more than 0% up to 5%, wherein the first colour application region adjoins the further colour application region.

In one embodiment 4 of the invention, the printed sheetlike composite 1 is configured according to embodiment 2 or 3, wherein the outer surface of the printed sheetlike composite is overlaid by m further colour applications, wherein the colour application and the m further colour applications each comprise a different colourant, wherein each of the m further colour applications is characterized by a number of missing dots in a range from 0 to 100, preferably from 0 to 70, more preferably from 0 to 60, more preferably from 0 to 40, more preferably from 0 to 30, more preferably from 0 to 20, more preferably from 0 to 10, most preferably from 0 to 8, in each case per 100 mm², where m is a natural number and is at least 1, preferably at least 2, more preferably at least 3, most preferably at least 4. Particularly preferable, m is 5.

A contribution to the achievement of at least one of the objects of the invention is made by an embodiment 1 of an apparatus 1 comprising, as apparatus constituents:
a) a feed device, wherein the feed device is arranged and designed to accommodate a sheetlike composite comprising, as mutually superposed layers, from an outer surface of the sheetlike composite to an inner surface (202) of the sheetlike composite,
   i) a carrier layer,
   ii) a barrier layer, and
   iii) an inner polymer layer;
b) n components, where, for every i from 1 to n,
   i) the ith component comprises an ith component surface, and
   ii) the ith component surface comprises a multitude of recesses,
   wherein the recesses are each designed to accommodate a composition comprising a colourant,
   wherein the n components are arranged after the feed device looking downstream,
   wherein, for every i from 1 to (n−1), the (i+1)th component is arranged after the ith component looking downstream; and
c) n electrodes, where, for every i from 1 to n, the ith electrode
   i) is arranged and designed for exchange of electrical charge carriers with the outer surface of the sheetlike composite,
   ii) is arranged before the ith component looking downstream;

where n is a natural number and is at least 2, where i is a natural number. Preferably, n is at least 3, more preferably at least 4, more preferably at least 5, even more preferably at least 6. Particularly preferable, n is exactly 5 or 6. In some configurations of the invention, n may also be 10 or greater than 10.

In one embodiment 2 of the invention, apparatus 1 is configured according to embodiment 1, wherein the n electrodes are designed and arranged such that, for every odd i from 1 to n, the exchange of electrical charge carriers with the outer surface of the sheetlike composite can proceed in the opposite sense from the exchange of electrical charge carriers with the outer surface of the sheetlike composite and the ith electrode for every even i.

In one embodiment 3 of the invention, apparatus 1 is configured according to embodiment 1 or 2, wherein the apparatus downstream of the nth component comprises an (n+1)th electrode, wherein the (n+1)th electrode is arranged and designed in order to earth the sheetlike composite on the outer surface.

In one embodiment 4 of the invention, apparatus 1 is configured according to any of its preceding embodiments, wherein the apparatus downstream of the nth component comprises a removal device, wherein the removal device is arranged and designed in order to accommodate the sheetlike composite. A preferred removal device is arranged and designed for rolling-up of the sheetlike composite.

In one embodiment 5 of the invention, apparatus 1 is configured according to any of its preceding embodiments, wherein the barrier layer is electrically insulating.

In one embodiment 6 of the invention, apparatus 1 is configured according to any of the embodiments 1 to 4, wherein the barrier layer is electrically conductive.

In one embodiment 7 of the invention, apparatus 1 is configured according to any of its preceding embodiments, wherein the apparatus comprises n further components, wherein, for every i from 1 to n, the ith component is arranged and designed such that a region of the sheetlike composite can make contact at the outer surface with the ith component and simultaneously at the inner surface with the ith further component.

In one embodiment 8 of the invention, apparatus 1 is configured according to any of its preceding embodiments, wherein the n components are designed so as to be rotatable about a respective axis.

In one embodiment 9 of the invention, apparatus 1 is configured according to any of its preceding embodiments, wherein, for every i from 1 to n, the ith component and the ith further component are designed so as to be rotatable in opposite senses about a respective axis.

In one embodiment 9 of the invention, apparatus 1 is configured according to any of its preceding embodiments, wherein the n components are intaglio print rolls.

In one embodiment 10 of the invention, apparatus 1 is configured according to any of its preceding embodiments, wherein the n components are each earthed.

In one embodiment 11 of the invention, apparatus 1 is configured according to any of its embodiments 7 to 10, wherein the n further components are impression rolls. The impression rolls are preferably earthed.

In one embodiment 12 of the invention, apparatus 1 is configured according to any of its preceding embodiments, wherein the sheetlike composite further comprises, on a side of the carrier layer facing the outer surface, an outer polymer layer, wherein the outer polymer layer is characterized by a layer thickness in a range from 1 to 30 μm, preferably from 2 to 25 μm, more preferably from 3 to 20 μm, most preferably from 3 to 10 μm.

In one embodiment 13 of the invention, apparatus 1 is configured according to any of its preceding embodiments, wherein the sheetlike composite is characterized by an ignition residue determined by the method described herein in a range from 0.1 to 75 mg, preferably from 0.2 to 50 mg, more preferably from 0.3 to 30 mg, most preferably from 0.3 to 25 mg.

In one embodiment 14 of the invention, apparatus 1 is configured according to any of its preceding embodiments, wherein the outer surface is a surface of the carrier layer.

In one embodiment 15 of the invention, apparatus 1 is configured according to any of its preceding embodiments, wherein the inner polymer layer comprises a polymer prepared by means of a metallocene catalyst to an extent of 10% to 90% by weight, preferably to an extent of 25% to 90% by weight, more preferably to an extent of 30% to 80% by weight, based in each case on the total weight of the inner polymer layer.

In one embodiment 16 of the invention, apparatus 1 is configured according to any of its preceding embodiments, wherein the inner polymer layer comprises a polymer blend, wherein the polymer blend comprises an mPE to an extent of 10% to 90% by weight, preferably to an extent of 25% to 90% by weight, more preferably to an extent of 30% to 80% by weight, and a further polymer to an extent of at least 10% by weight, preferably to an extent of at least 15% by weight, more preferably to an extent of at least 20% by weight, based in each case on the total weight of the polymer blend.

In one embodiment 17 of the invention, apparatus 1 is configured according to any of its preceding embodiments, wherein the carrier layer is one selected from the group consisting of cardboard, paperboard and paper, or a combination of at least two thereof, and preferably consists thereof.

In one embodiment 18 of the invention, apparatus 1 is configured according to any of its preceding embodiments, wherein the carrier layer has at least one hole, wherein the hole is covered at least by the barrier layer and at least by the inner polymer layer as hole-covering layers.

In one embodiment 19 of the invention, apparatus 1 is configured according to any of its preceding embodiments, wherein the outer surface is not comprised by a cover layer of the carrier layer.

A contribution to the achievement of at least one of the objects of the invention is made by an embodiment 1 of a printed sheetlike composite 2, comprising, as mutually superposed layers, from an outer surface of the printed sheetlike composite to an inner surface of the printed sheetlike composite,
i) a colour application,
ii) a carrier layer,
iii) a barrier layer, and
iv) an inner polymer layer,

wherein the printed sheetlike composite is characterized by an ignition residue determined by the method described herein in a range from 0.1 to 75 mg, preferably from 0.2 to 50 mg, more preferably from 0.3 to 30 mg, most preferably from 0.3 to 25 mg.

In one embodiment 2 of the invention, the printed sheetlike composite 2 is configured according to embodiment 1, wherein the colour application is characterized by a number of missing dots in a range from 0 to 100, preferably from 0 to 70, more preferably from 0 to 60, more preferably from 0 to 40, more preferably from 0 to 30, more preferably from 0 to 20, more preferably from 0 to 10, most preferably from 0 to 8, in each case per 100 mm².

In one embodiment 3 of the invention, the printed sheetlike composite 2 is configured according to embodiment 1 or 2, wherein the carrier layer on a side of the carrier layer remote from the barrier layer is overlaid by m further colour applications, wherein the colour application and the m further colour applications each comprise a different colourant, wherein each of the m further colour applications is characterized by a number of missing dots in a range from 0 to 100, preferably from 0 to 70, more preferably from 0 to 60, more preferably from 0 to 40, more preferably from 0 to 30, more preferably from 0 to 20, more preferably from 0 to 10, most preferably from 0 to 8, in each case per 100 mm², where m is a natural number and is at least 1, preferably at least 2, more preferably at least 3, most preferably at least 4. Particularly preferable, m is 5.

In one embodiment 4 of the invention, the printed sheetlike composite 2 is configured according to any of its preceding embodiments, wherein the printed sheetlike composite further comprises, between the colour application and the carrier layer, an outer polymer layer, wherein the outer polymer layer is characterized by a layer thickness in a range from 1 to 30 μm, preferably from 2 to 25 μm, more preferably from 3 to 20 μm, most preferably from 3 to 10 μm.

A contribution to the achievement of at least one of the objects of the invention is made by an embodiment 1 of a printed sheetlike composite 3, comprising, as mutually superposed layers, from an outer surface of the printed sheetlike composite to an inner surface of the printed sheetlike composite,
i) a colour application,
ii) an outer polymer layer,
iii) a carrier layer,
iv) a barrier layer, and
v) an inner polymer layer,

wherein the outer polymer layer is characterized by a layer thickness in a range from 1 to 30 μm, preferably from 2 to 25 μm, more preferably from 3 to 20 μm, most preferably from 3 to 10 μm.

In one embodiment 2 of the invention, the printed sheetlike composite 3 is configured according to embodiment 1, wherein the outer polymer layer is overlaid on a side of the outer polymer layer remote from the carrier layer by m further colour applications, wherein the colour application and the m further colour applications each comprise a different colourant, where m is a natural number and is at least 1, preferably at least 2, more preferably at least 3, most preferably at least 4. Particularly preferable, m is exactly 4 or 5.

In one embodiment 3 of the invention, the printed sheetlike composite 3 is configured according to embodiment 1 or 2, wherein the printed sheetlike composite is characterized by an ignition residue determined by the method described herein in a range from 0.1 to 75 mg, preferably from 0.2 to 50 mg, more preferably from 0.3 to 30 mg, most preferably from 0.3 to 25 mg.

In one embodiment 4 of the invention, the printed sheetlike composite 3 is configured according to any of its embodiments 1 to 3, wherein the colour application comprises a first colour application region and a further colour application region, wherein the first colour application region is characterized by an area coverage of at least 50%, preferably of at least 60%, more preferably of at least 70%, more preferably of at least 80%, most preferably of at least 90%, wherein the further colour application region is characterized by an area coverage in a range from more than 0% up to 15%, preferably from more than 0% up to 13%, more preferably from more than 0% up to 11%, more preferably from more than 0% up to 9%, most preferably from more than 0% up to 5%, wherein the first colour application region adjoins the further colour application region. In one embodiment 5 of the invention, the printed sheetlike composite 2 is configured according to any of its embodiments 1 to 4, wherein the colour application comprises a first colour application region and a further colour application region, wherein the first colour application region is characterized by an area coverage of at least 50%, preferably of at least 60%, more preferably of at least 70%, more preferably of at least 80%, most preferably of at least 90%, wherein the further colour application region is characterized by an area coverage in a range from more than 0% up to 15%, preferably from more than 0% up to 13%, more preferably from more than 0% up to 11%, more preferably from more than 0% up to 9%, most preferably from more than 0% up to 5%, wherein the first colour application region adjoins the further colour application region. The aforementioned degrees of area coverage preferably relate to the same colour.

In one embodiment 5 of the invention, the printed sheetlike composite 3 is configured according to any of its embodiments 1 to 4, wherein the colour application is characterized by a number of missing dots in a range from 0 to 100, preferably from 0 to 70, more preferably from 0 to 60, more preferably from 0 to 40, more preferably from 0 to 30, more preferably from 0 to 20, more preferably from 0 to 10, most preferably from 0 to 8, in each case per 100 mm². In one embodiment 6 of the invention, the printed sheetlike composite 3 is configured according to any of its embodiments 1 to 5, wherein the colour application is characterized by a number of missing dots in a range from 0 to 100, preferably from 0 to 70, more preferably from 0 to 60, more preferably from 0 to 40, more preferably from 0 to 30, more preferably from 0 to 20, more preferably from 0 to 10, most preferably from 0 to 8, in each case per 100 mm². In the aforementioned embodiments, it is further preferable that the m further colour applications are each characterized by a number of missing dots in a range from 0 to 100, preferably from 0 to 70, more preferably from 0 to 60, more preferably from 0 to 40, more preferably from 0 to 30, more preferably from 0 to 20, more preferably from 0 to 10, most preferably from 0 to 8, in each case per 100 mm².

A contribution to the achievement of at least one of the objects of the invention is made by an embodiment 1 of a container precursor at least partly comprising the printed sheetlike composite 1, 2 or 3, in each case according to any of its aforementioned embodiments.

A contribution to the achievement of at least one of the objects of the invention is made by an embodiment 1 of a closed container 1 at least partly comprising the printed sheetlike composite 1, 2 or 3, in each case according to any of its aforementioned embodiments, wherein the printed sheetlike composite has been folded at least once, preferably at least twice, more preferably at least 3 times, even more preferably at least 5 times, most preferably at least 10 times.

A contribution to the achievement of at least one of the objects of the invention is made by an embodiment 1 of a use 1 of the apparatus 1 according to any of its aforementioned embodiments for printing of the sheetlike composite.

In one embodiment 2 of the invention, the use 1 is configured according to its embodiment 1, wherein the printing is effected directly onto a surface of the carrier layer.

Preferred configurations of constituents of any category of the invention, especially of the method, the printed sheetlike composite, the container precursor, the closed container, the apparatus and the use, are likewise preferred for constituents of the same name or corresponding constituents of the respective other categories of the invention.

Colour Application

A colour application comprises at least one colourant. A preferred colour application consists of a multitude of preferably printed dots. The colour application, or the colour application and the further colour applications, preferably form a decoration.

Outer Surface

The outer surface of the sheetlike composite is the surface which faces predominantly outward in a container to be produced from the sheetlike composite. Accordingly, the outer surface is in direct contact with an environment of the container. In the sheetlike composite, the outer surface and the inner surface form mutually opposite surfaces of the sheetlike composite.

Inner Surface

The inner surface of the sheetlike composite is a surface of a ply of the sheetlike composite which is intended to be in contact with the contents of the container, preferably a food or drink product, in a container to be produced from the sheetlike composite.

Layers

Unless stated otherwise, in a layer sequence, the layers may follow one another indirectly, i.e. with one or at least two intermediate layers, or directly, i.e. with no intermediate layer. This is the case especially in the form of words where one layer overlays another layer. A form of words where a layer sequence comprises enumerated layers means that at least the layers specified are present in the sequence specified. This form of words does not necessarily mean that these layers follow on directly from one another. A form of words where two layers adjoin one another means that these two layers follow on from one another directly and hence with no intermediate layer.

Polymer Layers

The term “polymer layer” refers hereinafter especially to the inner polymer layer, the outer polymer layer and the intermediate polymer layer. An intermediate polymer layer refers here to a polymer layer between the carrier layer and the barrier layer. A preferred polymer is a polyolefin. The polymer layers may have further constituents. The polymer layers are preferably introduced into or applied to the sheetlike composite material in an extrusion method. The further constituents of the polymer layers are preferably constituents that do not adversely affect the behaviour of the polymer melt on application as a layer. The further constituents may, for example, be inorganic compounds, such as metal salts, or further plastics, such as further thermoplastics. However, it is also conceivable that the further constituents are fillers or pigments, for example carbon black or metal oxides. Suitable thermoplastics for the further constituents especially include those that are readily processible by virtue of good extrusion characteristics. Among these, polymers obtained by chain polymerization are suitable, especially polyesters or polyolefins, particular preference being given to cyclic olefin copolymers (COCs), polycyclic olefin copolymers (POCs), especially polyethylene and polypropylene, and very particular preference to polyethylene. Among the polyethylenes, preference is given to HDPE (high density polyethylene), MDPE (medium density polyethylene), LDPE (low density polyethylene), LLDPE (linear low density polyethylene), VLDPE (very low density polyethylene) and PE (polyethylene), and mixtures of at least two thereof. It is also possible to use mixtures of at least two thermoplastics. Suitable polymer layers have a melt flow rate (MFR) in a range from 1 to 25 g/10 min, preferably in a range from 2 to 20 g/10 min and more preferably in a range from 2.5 to 15 g/10 min, and a density in a range from 0.890 g/cm³ to 0.980 g/cm³, preferably in a range from 0.895 g/cm³ to 0.975 g/cm³, and further preferably in a range from 0.900 g/cm³ to 0.970 g/cm³. The polymer layers preferably have at least one melting temperature in a range from 80 to 155° C., preferably in a range from 90 to 145° C. and more preferably in a range from 95 to 135° C.

Inner Polymer Layer

The inner polymer layer is based on thermoplastic polymers, where the inner polymer layer may include a particulate inorganic solid. However, it is preferable that the inner polymer layer in comprises a thermoplastic polymer to an extent of at least 70% by weight, preferably at least 80% by weight and more preferably at least 95% by weight, based in each case on the total weight of the inner polymer layer. Preferably, the polymer or polymer mixture of the inner polymer layer has a density (to ISO 1183-1:2004) in a range from 0.900 to 0.980 g/cm³, more preferably in a range from 0.900 to 0.960 g/cm³ and most preferably in a range from 0.900 to 0.940 g/cm³.

Carrier Layer

The carrier layer used may be any material which is suitable for a person skilled in the art for this purpose and which has sufficient strength and stiffness to impart stability to the container to such an extent that the container in the filled state essentially retains its shape. This is, in particular, a necessary feature of the carrier layer since the invention relates to the technical field of dimensionally stable containers. As well as a number of plastics, preference is given to plant-based fibrous materials, especially pulps, preferably sized, bleached and/or unbleached pulps, paper and paperboard being especially preferred. The weight per unit area of the carrier layer is preferably in a range from 120 to 450 g/m², especially preferably in a range from 130 to 400 g/m² and most preferably in a range from 150 to 380 g/m². A preferred paperboard generally has a single-layer or multilayer structure and may have been coated on one or both sides with one or else more than one cover layer. In addition, a preferred paperboard has a residual moisture content of less than 20% by weight, preferably of 2% to 15% by weight and especially preferably of 4% to 10% by weight, based on the total weight of the paperboard. A more particularly preferred paperboard has a multilayer structure. Further preferably, the paperboard has, on the surface facing the environment, at least one lamina, but more preferably at least two laminas, of a cover layer known to the person skilled in the art as a “paper coating”. In addition, a more paperboard has a Scott bond value in a range from 100 to 360 J/m², preferably from 120 to 350 J/m² and especially preferably from 135 to 310 J/m². By virtue of the aforementioned ranges, it is possible to provide a composite from which it is possible to fold a container with high integrity, easily and in low tolerances.

Barrier Layer

The barrier layer used may be any material which is suitable for a person skilled in the art for this purpose and which has sufficient barrier action, especially with respect to oxygen. The barrier layer is preferably selected from
a. a plastic barrier layer as electrically insulating barrier layer;
b. a metal layer as electrically conductive barrier layer;
c. a metal oxide layer; or
d. a combination of at least two of a. to c.

If the barrier layer, according to alternative a., is a plastic barrier layer, this preferably comprises at least 70% by weight, especially preferably at least 80% by weight and most preferably at least 95% by weight of at least one plastic which is known to the person skilled in the art for this purpose, especially for aroma or gas barrier properties suitable for packaging containers. Useful plastics, especially thermoplastics, here include N- or O-bearing plastics, either alone or in mixtures of two or more. According to the invention, it may be found to be advantageous when the plastic barrier layer has a melting temperature in a range from more than 155 to 300° C., preferably in a range from 160 to 280° C. and especially preferably in a range from 170 to 270° C.

Further preferably, the plastic barrier layer has a weight per unit area in a range from 2 to 120 g/m², preferably in a range from 3 to 60 g/m², especially preferably in a range from 4 to 40 g/m² and further preferably from 6 to 30 g/m². Further preferably, the plastic barrier layer is obtainable from melts, for example by extrusion, especially laminar extrusion. Further preferably, the plastic barrier layer may also be introduced into the sheetlike composite via lamination. It is preferable in this context that a film is incorporated into the sheetlike composite. In another embodiment, it is also possible to select plastic barrier layers obtainable by deposition from a solution or dispersion of plastic.

Suitable polymers preferably include those having a weight-average molecular weight, determined by gel permeation chromatography (GPC) by means of light scattering, in a range from 3×10³ to 1·10⁷ g/mol, preferably in a range from 5·10³ to 1·10⁶ g/mol and especially preferably in a range from 6·10³ to 1·10⁵ g/mol. Suitable polymers especially include polyamide (PA) or polyethylene vinyl alcohol (EVOH) or a mixture thereof.

Among the polyamides, useful PAs are all of those that seem suitable to the person skilled in the art for the use according to the invention. Particular mention should be made here of PA 6, PA 6.6, PA 6.10, PA 6.12, PA 11 or PA 12 or a mixture of at least two thereof, particular preference being given to PA 6 and PA 6.6 and further preference to PA 6. PA 6 is commercially available, for example, under the Akulon®, Durethan® and Ultramid® trade names. Additionally suitable are amorphous polyamides, for example MXD6, Grivory® and Selar® PA. It is further preferable that the PA has a density in a range from 1.01 to 1.40 g/cm³, preferably in a range from 1.05 to 1.30 g/cm³ and especially preferably in a range from 1.08 to 1.25 g/cm³. It is further preferable that the PA has a viscosity number in a range from 130 to 250 ml/g and preferably in a range from 140 to 220 ml/g.

Useful EVOHs include all the EVOHs that seem suitable to the person skilled in the art for the use according to the invention. Examples of these are commercially available, inter alia, under the EVAL™ trade names from EVAL Europe NV, Belgium, in a multitude of different versions, for example the EVAL™ F104B or EVAL™ LR171B types. Preferred EVOHs have at least one, two, more than two or all of the following properties:
an ethylene content in a range from 20 to 60 mol %, preferably from 25 to 45 mol %;
a density in a range from 1.0 to 1.4 g/cm³, preferably from 1.1 to 1.3 g/cm³;
a melting point in a range from more than 155 to 235° C., preferably from 165 to 225° C.;
an MFR value (210° C./2.16kg when T_{S(EVOH)}<230° C.; 230° C./2.16 kg when 210° C. <T_{S(EVOH)}<230° C.) in a range from 1 to 25 g/l0 min, preferably from 2 to 20 g/10 min;
an oxygen permeation rate in a range from 0.05 to 3.2 cm³·20μm/m².day.atm, preferably in a range from 0.1 to 1 cm³·20μm/m²·day·atm.

Preferably at least one polymer layer, further preferably the inner polymer layer, or preferably all polymer layers, have a melting temperature below the melting temperature of the barrier layer. This is especially true when the barrier layer is formed from polymer. In this case, the melting temperatures of the at least one polymer layer, especially the inner polymer layer, and the melting temperature of the barrier layer differ preferably by at least 1 K, especially preferably by at least 10 K, even more preferably by at least 50 K, further preferably at least 100 K. The temperature difference should preferably be chosen only such that it is sufficiently high that there is no melting of the barrier layer, especially no melting of the plastic barrier layer, during the folding.

According to alternative b., the barrier layer is a metal layer. Suitable metal layers are in principle all layers comprising metals which are known to the person skilled in the art and which can provide high light opacity and oxygen impermeability. In a preferred embodiment, the metal layer may take the form of a foil or a deposited layer, for example after a physical gas phase deposition. The metal layer is preferably an uninterrupted layer. In a further preferred embodiment, the metal layer has a thickness in a range from 3 to 20 μm, preferably in a range from 3.5 to 12 μm and especially preferably in a range from 4 to 10 μm.

Metals selected with preference are aluminium, iron or copper. A preferred iron layer may be a steel layer, for example in the form of a foil. Further preferably, the metal layer is a layer comprising aluminium. The aluminium layer may appropriately consist of an aluminium alloy, for example AlFeMn, AlFe1.5Mn, AlFeSi or AlFeSiMn. The purity is typically 97.5% or higher, preferably 98.5% or higher, based in each case on the overall aluminium layer. In a preferred configuration, the metal layer consists of an aluminium foil. Suitable aluminium foils have a ductility of more than 1%, preferably of more than 1.3% and especially preferably of more than 1.5%, and a tensile strength of more than 30 N/mm², preferably more than 40 N/mm² and especially preferably more than 50 N/mm². Suitable aluminium foils in the pipette test show a droplet size of more than 3 mm, preferably more than 4 mm and especially preferably of more than 5 mm. Suitable alloys for creation of aluminium layers or foils are commercially available under the EN AW 1200, EN AW 8079 or EN AW 8111 names from Hydro Aluminium Deutschland GmbH or Amcor Flexibles Singen GmbH. In the case of a metal foil as barrier layer, it is possible to provide an adhesion promoter layer between the metal foil and a closest polymer layer on one and/or both sides of the metal foil.

Further preferably, the barrier layer selected, according to alternative c., may be a metal oxide layer. Useful metal oxide layers include all metal oxide layers that are familiar and seem suitable to the person skilled in the art, in order to achieve a barrier effect with respect to light, vapour and/or gas. Especially preferred are metal oxide layers based on the metals already mentioned above, aluminium, iron or copper, and those metal oxide layers based on titanium oxide or silicon oxide compounds. A metal oxide layer is produced by way of example by vapour deposition of metal oxide on a polymer layer, for example an oriented polypropylene film. A preferred method for this purpose is physical gas phase deposition.

In a further preferred embodiment, the metal layer of the metal oxide layer may take the form of a layer composite composed of one or more polymer layers with a metal layer. Such a layer is obtainable, for example, by vapour deposition of metal on a polymer layer, for example an oriented polypropylene film. A preferred method for this purpose is physical gas phase deposition.

Adhesion/Adhesion Promoter Layer

An adhesion promoter layer may be present between layers which do not directly adjoin one another, preferably between the barrier layer and the inner polymer layer. Useful adhesion promoters in an adhesion promoter layer include all polymers which are suitable for producing a firm bond through functionalization by means of suitable functional groups, through the forming of ionic bonds or covalent bonds with a surface of a respective adjacent layer. Preferably, these comprise functionalized polyolefins which have been obtained by copolymerization of ethylene with acrylic acids such as acrylic acid, methacrylic acid, crotonic acid, acrylates, acrylate derivatives or carboxylic anhydrides that bear double bonds, for example maleic anhydride, or at least two of these. Among these, preference is given to polyethylene-maleic anhydride graft polymers (EMAH), ethylene-acrylic acid copolymers (EAA) or ethylene-methacrylic acid copolymers (EMAA), which are sold, for example, under the Bynel® and Nucrel®0609HSA trade names by DuPont or Escor®6000ExCo by ExxonMobil Chemicals.

According to the invention, it is preferable that the adhesion between a carrier layer, a polymer layer or a barrier layer and the next layer in each case is at least 0.5 N/15 mm, preferably at least 0.7 N/15 mm and especially preferably at least 0.8 N/15 mm. In one configuration of the invention, it is preferable that the adhesion between a polymer layer and a carrier layer is at least 0.3 N/15 mm, preferably at least 0.5 N/15 mm and especially preferably at least 0.7 N/15 mm. It is further preferable that the adhesion between a barrier layer and a polymer layer is at least 0.8 N/15 mm, preferably at least 1.0 N/15 mm and especially preferably at least 1.4 N/15 mm. If a barrier layer indirectly follows a polymer layer with an adhesion promoter layer in between, it is preferable that the adhesion between the barrier layer and the adhesion promoter layer is at least 1.8 N/15 mm, preferably at least 2.2 N/15 mm and especially preferably at least 2.8 N/15 mm. In a particular configuration, the adhesion between the individual layers is sufficiently strong that a carrier layer is torn apart in an adhesion test, called a paperboard fibre tear in the case of a paperboard as carrier layer.

Adhesion Promoter

Useful adhesion promoters in the intermediate polymer layer include all polymers which are suitable for producing a firm bond through functionalization by means of suitable functional groups, through the forming of ionic bonds or covalent bonds with a surface of a respective adjacent layer. Preferably, these comprise functionalized polyolefins which have been obtained by copolymerization of ethylene with acrylic acids such as acrylic acid, methacrylic acid, crotonic acid, acrylates, acrylate derivatives or carboxylic anhydrides that bear double bonds, for example maleic anhydride, or at least two of these. Among these, preference is given to polyethylene-maleic anhydride graft polymers (EMAH), ethylene-acrylic acid copolymers (EAA) or ethylene-methacrylic acid copolymers (EMAA), which are sold, for example, under the Bynel® and Nucrel®0609HSA trade names by DuPont or Escor®6000ExCo by ExxonMobil Chemicals.

Polyolefin

A preferred polyolefin is a polyethylene (PE) or a polypropylene (PP) or both. A preferred polyethylene is one selected from the group consisting of an LDPE, an LLDPE, and an HDPE, or a combination of at least two thereof. A further preferred polyolefin is an mPolyolefin (polyolefin prepared by means of a metallocene catalyst). Suitable polyethylenes have a melt flow rate (MFR=MFI−melt flow index) in a range from 1 to 25 g/10 min, preferably in a range from 2 to 20 g/10 min and especially preferably in a range from 2.5 to 15 g/10 min, and a density in a range from 0.910 g/cm³ to 0.935 g/cm³, preferably in a range from 0.912 g/cm³ to 0.932 g/cm³, and further preferably in a range from 0.915 g/cm³ to 0.930 g/cm³.

mPolymer

An mPolymer is a polymer which has been prepared by means of a metallocene catalyst. Metallocene is an organometallic compound in which a central metal atom is arranged between two organic ligands, for example cyclopentadienyl ligands. A preferred mPolymer is an mPolyolefin, preferably an mPolyethylene or an mPolypropylene or both. A preferred mPolyethylene is one selected from the group consisting of an mLDPE, an mLLDPE, and an mHDPE, or a combination of at least two thereof.

Extrusion

In the extrusion, the polymers are typically heated to temperatures of 210 to 350° C., measured in the molten polymer film beneath the exit from the extruder die. The extrusion can be effected by means of extrusion tools which are known to those skilled in the art and are commercially available, for example extruders, extruder screws, feed blocks, etc. At the end of the extruder, there is preferably an opening through which the polymer melt is pressed. The opening may have any shape that allows extrusion of the polymer melt to the composite precursor. For example, the opening may be angular, oval or round. The opening is preferably in the form of a slot of a funnel. In a preferred configuration of the method, application is effected through a slot. The slot preferably has a length in a range from 0.1 to 100 m, preferably in a range from 0.5 to 50 m, especially preferably in a range from 1 to 10 m. In addition, the slot preferably has a width in a range from 0.1 to 20 mm, preferably in a range from 0.3 to 10 mm, especially preferably in a range from 0.5 to 5 mm. During the application of the polymer melt, it is preferable that the slot and the composite precursor move relative to one another. Preference is given to such a process wherein the composite precursor moves relative to the slot.

In a preferred extrusion coating method, the polymer melt is stretched during the application, this stretching preferably being effected by melt stretching, and most preferably by monoaxial melt stretching. For this purpose, the layer is applied to the composite precursor in the molten state by means of a melt extruder, and the layer applied, which is still in the molten state, is subsequently stretched in the preferably monoaxial direction, in order to achieve orientation of the polymer in this direction. Subsequently, the layer applied is left to cool for the purpose of heat-setting. In this context, it is especially preferable that the stretching is effected by at least the following application steps:
b1. emergence of the polymer melt as a melt film through at least one extruder die slot with an emergence velocity Vₒᵤₜ;
b2. application of the melt film to the composite precursor moving relative to the at least one extruder die slot with a movement velocity V_{for};

where Vₒᵤₜ<V_{for}. It is especially preferable that V_{for} is greater than Vₒᵤₜ by a factor in the range from 5 to 200, especially preferably in a range from 7 to 150, further preferably in a range from 10 to 50 and most preferably in a range from 15 to 35. It is preferable here that V_{for} is at least 100 m/min, especially preferably at least 200 m/min and most preferably at least 350 m/min, but typically not more than 1300 m/min. Once the melt layer has been applied to the composite precursor by means of the above-described stretching process, the melt layer is left to cool down for the purpose of heat-setting, this cooling preferably being effected by quenching via contact with a surface which is kept at a temperature in a range from 5 to 50° C., especially preferably in a range from 10 to 30° C.

In a further preferred configuration, the area which has emerged is cooled down to a temperature below the lowest melting temperature of the polymers provided in this area or its flanks, and then at least the flanks of the area are separated from this area. The cooling can be effected in any manner which is familiar to the person skilled in the art and seems to be suitable. Preference is given here too to the heat-setting which has already been described above. Subsequently, at least the flanks are separated from the area. The separation can be conducted in any manner which is familiar to the person skilled in the art and seems to be suitable. Preferably, the separation is effected by means of a knife, laser beam or waterjet, or a combination of two or more thereof, the use of knives being especially preferable, especially knives for shearing.

Food and Drink Products

The present sheetlike composite and the container precursor are preferably designed for production of a food or drink product container. In addition, the closed container according to the invention is preferably a food or drink product container. Food and drink products include all kinds of food and drink known to those skilled in the art for human consumption and also animal feeds. Preferred food and drink products are liquid above 5° C., for example milk products, soups, sauces, non-carbonated drinks.

Colourant

According to DIN 55943:2001-10, colourant is the collective term for all colouring substances, especially for dyes and pigments. A preferred colourant is a pigment. A preferred pigment is an organic pigment. Pigments that are notable in connection with the invention are especially the pigments mentioned in DIN 55943:2001-10 and those mentioned in “Industrial Organic Pigments, Third Edition” (Willy Herbst, Klaus Hunger Copyright © 2004 WILEY-VCH Verlag GmbH & Co. KGaA, Weinheim ISBN: 3-527-30576-9).

Container

The closed container according to the invention may have a multitude of different forms, but preference is given to an essentially cuboidal structure. In addition, the full area of the container may be formed from the sheetlike composite, or it may have a two-part or multipart construction. In the case of a multipart construction, it is conceivable that, as well as the sheetlike composite, other materials are also used, for example plastic, which can be used particularly in the top or base regions of the container. In this context, however, it is preferable that the container is formed from the sheetlike composite to an extent of at least 50%, especially preferably to an extent of at least 70% and further preferably to an extent of at least 90% of the area. In addition, the container may have a device for emptying the contents. This may be formed, for example, from a polymer or mixture of polymers and be mounted on the outside of the container. It is also conceivable that this device has been integrated into the container by direct injection moulding. In a preferred configuration, the container according to the invention has at least one edge, preferably from 4 to 22 or else more edges, especially preferably from 7 to 12 edges. Edges in the context of the present invention are understood to mean regions which arise in the folding of a surface. Examples of edges include the longitudinal contact regions between two wall surfaces of the container in each case, also referred to as longitudinal edges herein. In the container, the container walls are preferably the surfaces of the container framed by the edges. Preferably, the interior of a container according to the invention comprises a food or drink product. Preferably, the closed container does not comprise any lid or base, or either, that has not been formed in one piece with the sheetlike composite. A preferred closed container comprises a food or drink product.

Container Precursor

A container precursor is a precursor of the closed container which arises in the course of production of a closed container. In this context, the container precursor comprises the sheetlike composite in the form of a blank. In this context, the sheetlike composite may be in an unfolded or folded state. A preferred container precursor has been cut to size and is designed for production of a single closed container. A preferred container precursor which has been cut to size and is designed for production of a single closed container is also referred to as a shell or sleeve. In this context, the shell or sleeve comprises the sheetlike composite in folded form. Moreover, the shell or sleeve comprises a longitudinal seam and is open in a top region and a base region. A typical container precursor which has been cut to size and is designed for production of a multitude of closed containers is often also referred to as a tube. A further preferred container precursor is open, preferably in a top region or a base region, more preferably in both. A preferred container precursor is in the form of a shell or tube or both. A further preferred container precursor comprises the printed sheetlike composite in such a way that the printed sheetlike composite has been folded at least once, preferably at least twice, more preferably at least 3 times, most preferably at least 4 times. A preferred container precursor is in one-piece form. More preferably, a base region of the container precursor is in a one-piece design with a lateral region of the container precursor.

Components

The components are designed to accommodate printing ink in the recesses, also called cells, and for transfer of at least a portion of the printing ink from the recesses on the outer surface of the sheetlike composite. For this purpose, the outer surface is preferably pressed onto the respective component surface. A preferred component is a print roll. A preferred print roll is an intaglio print roll. A preferred component surface takes the form of an outer cylindrical surface. A preferred further component is a further roll. A preferred further roll is a backing roll. A preferred backing roll is an impression roll. The impression roll preferably consists of a hard material, such as wood or metal, coated with a rubber layer.

Composition

A preferred composition is a solution or a suspension or both. A further preferred composition is a printing ink. A preferred printing ink is a printing ink for intaglio printing. A preferred colourant is a pigment. The composition preferably comprises a convex surface in each of the recesses.

Contacting/Printing

A preferred contacting method is pressing. The contacting method is preferably printing. In this case, the sheetlike composite is preferably guided through a gap between the intaglio print roll and the impression roll.

Cover Layer

A preferred cover layer is a “paper coating”. A “paper coating” in papermaking is a cover layer comprising inorganic solid particles, preferably pigments and additives. The “paper coating” is preferably applied as a liquid phase, preferably as a suspension or dispersion, to a surface of a paper- or paperboard-containing layer. A preferred dispersion is an aqueous dispersion. A preferred suspension is an aqueous suspension. A further preferred liquid phase comprises inorganic solid particles, preferably pigments; a binder; and additives. A preferred pigment is selected from the group consisting of calcium carbonate, kaolin, talc, silicate, a plastic pigment and titanium dioxide. A preferred kaolin is a calcined kaolin. A preferred calcium carbonate is one selected from the group consisting of marble, chalk and a precipitated calcium carbonate (PCC) or a combination of at least two thereof. A preferred silicate is a sheet silicate. A preferred plastic pigment is spherical, preferably hollow spherical. A preferred binder is one selected from the group consisting of styrene-butadiene, acrylate, acrylonitrile, a starch and a polyvinyl alcohol or a combination of at least two thereof, preference being given to acrylate. A preferred starch is one selected from the group consisting of cationically modified, anionically modified and fragmented starch or a combination of at least two thereof. A preferred additive is one selected from the group consisting of a rheology modifier, a tinting dye, an optical brightener, a carrier for an optical brightener, a flocculating agent, a deaerator and a surface energy modifier or a combination of at least two thereof. A preferred deaerator is an brush paint deaerator, preferably based on silicone or based on fatty acids or both. A preferred surface energy modifier is a surfactant.

### Test Methods

The test methods which follow were utilized in the context of the invention. Unless stated otherwise, the measurements were conducted at an ambient temperature of 23° C., an ambient air pressure of 100 kPa (0.986 atm) and a relative air humidity of 50%.

MFR

MFR is measured according to standard ISO 1133 (unless stated otherwise at 190° C. and 2.16 kg).

Density

Density is measured according to standard ISO 1183-1.

Melting Temperature

The melting temperature is determined on the basis of the DSC method ISO 11357-1, -5. The instrument is calibrated according to the manufacturer's instructions on the basis of the following measurements:
temperature indium—onset temperature,
heat of fusion indium,
temperature zinc—onset temperature.

Oxygen Permeation Rate

Oxygen permeation rate is determined according to standard ISO 14663-2 Appendix C at 20° C. and 65% relative air humidity.

Moisture Content of Paperboard

Moisture content of paperboard is measured according to standard ISO 287:2009.

Viscosity Number of PA

Viscosity number of PA is measured according to standard ISO 307 in 95% sulphuric acid.

Adhesion

The adhesion of two adjacent layers is determined by fixing them in a 90° peel test instrument, for example the Instron “German rotating wheel fixture”, on a rotatable roller which rotates at 40 mm/min during the measurement. The samples had been cut beforehand into strips of width 15 mm. On one side of the sample, the laminas are detached from one another and the detached end is clamped in a tensile device directed vertically upward. A measuring instrument to determine the tensile force is attached to the tensile device. As the roller rotates, the force needed to separate the laminas from one another is measured. This force corresponds to the adhesion of the layers to one another and is reported in N/15 mm. The separation of the individual layers can be effected mechanically, for example, or by means of a controlled pretreatment, for example by soaking the sample in 30% acetic acid at 60° C. for 3 min.

Detection of Colourants

Detection of organic colourants can be conducted in accordance with the methods described in “Industrial Organic Pigments, Third Edition” (Willy Herbst, Klaus Hunger Copyright © 2004 WILEY-VCH Verlag GmbH & Co. KGaA, Weinheim ISBN: 3-527-30576-9).

Molecular Weight Distribution

Molecular weight distribution is measured by gel permeation chromatography by means of light scattering: ISO 16014-3/-5.

Missing Dots

For examination in a light microscope, five regions of the printed container, container precursor or laminate with a size of 10 mm×10 mm are examined. An unprinted dot in the print matrix corresponds to a missing dot. The missing dots are counted for each of the five regions. The arithmetic mean (average value) of the five measurements corresponds to the value “Missing dots”.

Area Coverage

The area coverage is a measure of the extent to which a colour surface appears to be covered to a normal observer. The area coverage can be calculated by the Murray-Davies formula. All area coverage values in this document were measured with the aid of a spectrophotometer (SpectroEye™) from X-Rite (Ch-8105 Regensdorf).

Electrical Voltages

If a charge of the laminate by an electrode or a voltage of the laminate is to be measured, the measurement is conducted in transverse direction (transverse to the web movement) in the middle of the composite material web at a distance of 1 cm with a Fluke 280 combined with a Fluke 80k-6 high-voltage probe from Fluke Deutschland GmbH, Glottertal, Germany. In addition, the measurement is conducted in the direction of web movement midway between the electrode by which the electrical charges are applied to the sheetlike composite and the component with which the sheetlike composite is printed, on the outer surface of the laminate. The measuring instrument measures the electrical field as a measure of the charge on the sheetlike composite. In addition, the measuring instrument determines the electrical voltage applied therefrom. The same measuring instrument is also used to measure the further electrical voltages cited herein.

Ignition Residue

In accordance with the standard DIN EN ISO 186 (in a departure from DIN EN 20 287), specimens of 50 mm×50 mm in size (0.0025 m²) are created from the packaging containers or packaging container precursors or laminates to be tested in order to determine the ignition loss.

Subsequently, the following steps are conducted:
1. The paperboard plies are separated by pulling them apart. This involves separating the outer paperboard ply together with the paper coating layer and any outer polymer layer present from the centre ply. The centre ply comprising the inner polymer layer is discarded.
2. Any outer polymer layer present and the outer ply of the paperboard including the paper coating are subsequently converted to ash according to DIN 54370 by ignition method A at 575° C. for about 3 hours.
3. The ignition residue is weighed. The absolute value is reported in milligrams (mg).

Layer Thickness of the Outer Polymer Layer/Colour Application

A sample of about 2.5 to 3.0 cm×1.0 to 1.5 cm in size is taken from the composite material (laminate, sheetlike composite) to be examined. The longitudinal side of the sample is taken transverse to the running direction of the extrusion and the fibre direction of the paperboard. The sample is fixed in a metal clamp which forms a smooth surface. The sample excess should not be more than 2-3 mm. The metal clamp is fixed prior to the cut. In order to obtain a clean cut, especially of the paperboard fibres, the portion of the sample protruding from the metal clamp is iced with cold spray. Subsequently, this portion is removed with a disposable blade. The fixing of the sample in the metal clamp is then loosened such that the sample can be moved about 3-4 nun out of the metal clamp. It is then fixed again. For examination in a light microscope, the sample in the sample holder is placed onto the stage of the light microscope under one of the objectives. The appropriate objective should be selected according to the layer thickness of the region to be examined. Exact centring is effected in the course of microscope examination. The light source used in most cases is a lateral illumination (swan's neck). If required, additionally or alternatively, the epiluminescent light source of the light microscope is used. If the sample has been optimally focused and illuminated, the individual layers of the composite are apparent. Documentation and measurements are accomplished with an Olympus camera having appropriate image processing software from Analysis. The layer thickness of the outer polymer layer is reported in absolute terms in micrometres (um).

### LIST OF INSTRUMENTS AND MATERIALS

Light microscope; Nikon Eclipse E800

Objectives; magnification X2.5; X5; X10; X20; X50

Illumination: swan's neck

Camera: Olympus DP 71

Software: analySIS

Disposable microtome blades; from Leica

Sample holder: metal clamp

Cold spray

Allen key

Vice

Cut-resistant gloves

Scissors

The invention is illustrated further by way of example hereinafter by examples. The invention is not restricted to the examples.

Production of the Composite Material (Laminate)

A commercial uncoated paperboard (NaturaD UC 200 mN; Stora Enso AB; Stockholm, Sweden) is treated according to the following steps:
1. First of all, the paperboard is coated in the laboratory according to the examples and comparative examples with one or more coats of a liquid paper coating. The number of paper coating layers to be applied is guided by the ignition residue of the laminate which is to be achieved. The ignition residue is reported in each case in the tables for the examples and comparative examples below. The formulation of the paper coatinghere is: 100 parts pigment (Hydrocarb 60; Omya Inc; Cincinnati, US) and 20 parts binder/SB latex (MAINCOTE™ HG-56; Dow; Germany). In this context, a sheetlike composite having an ignition residue of 50 mg has a twice-paper-coated carrier layer, a sheetlike composite having an ignition residue of 30 mg has a once-paper-coated carrier layer, and a sheetlike composite having an ignition residue of 2 mg has a carrier layer which is not coated with a paper coating.
2. In the extrusion coating process, the coated paperboards are coated with an outer polymer layer and the inner layers specified below. The laminate is produced with an extrusion coating system from Davis Standard. In the first step, the outer polymer layer is applied to the carrier layer. In the second step, the lamination layer is applied together with the barrier layer to the carrier layer that has been coated with the outer polymer layer beforehand. In the last step, the inner polymer layer is applied to the barrier layer. For application of the individual layers, the polymers or polymer blends are melted in an extruder. In the case of application of one polymer or polymer blend in a layer, the resultant melt is transferred via a feed block into a nozzle and extruded onto the carrier layer. In the case of application of two or more polymers or polymer blends in a layer, the resultant of melts are combined by means of a feed block and then co-extruded onto the carrier layer.
3. The composite materials obtained are printed with a decoration composed of 6 colour applications by intaglio printing either
   a) entirely without charging of the laminate (non-inventive comparative examples),
   b) with charging via the impression roll which makes contact with the inner surface (inner polymer layer) of the laminate,
   c) with charging by means of one electrode upstream of each print roll-impression roll pair, with the same voltage applied to all electrodes, or
   d) with charging via a charge electrode upstream of each print roll-impression roll pair and discharging via a discharge electrode arranged downstream of each print roll-impression roll pair,
   e) with charging by means of an electrode upstream of each print roll-impression roll pair, with application of a voltage of different sign in successive electrodes and matching of the values of the voltages to one another.
   Thus, according to point d), there is one charge electrode and one discharge electrode between successive print roll-impression roll pairs. According to points c) and e), there is only one electrode in each case between successive print roll-impression roll pairs. For the printing with the 6-colour decoration, 6 print roll-impression roll pairs are used in succession.
4. The print quality is analysed in accordance with the test methods.

### EXAMPLES AND COMPARATIVE EXAMPLES WITH AN ELECTRICALLY CONDUCTIVE BARRIER LAYER

For Examples 1 to 15 and Comparative Examples 1 to 7 adduced hereinafter, laminates having the layer structure which follows were used. These were obtained according to the above points 1. to 4.

Colour decoration
Outer polymer layer: LDPE Novex ® M19N430 from Ineos Köln GmbH
Paper coating
Carrier layer: NaturaD UC 200 mN; Stora Enso AB; Stockholm, Sweden
LDPE Novex ® M19N430 from Ineos Koln GmbH
Barrier layer: Aluminium EN A W 8079 from Hydro Aluminium
Deutschland GmbH with layer thickness 6 μm
PE blend comprising an mLDPE to an extent of 30% by weight
and an LDPE to an extent of 70% by weight with weight
per unit area 22 g/m²

### Comparative Examples 1 to 4 (Non-Inventive)

For Comparative Examples 1 to 4, the printing was effected according to the above point 3a) entirely without charging of the laminate.

| | | | | Number |
|---|---|---|---|---|
| | | | Number | of missing |
| | Thickness of | | of missing | dots in |
| | outer | | dots in | each of |
| | polymer | Ignition | colour | colour |
| Comparative | layer | residue | application 1 | applications 2-6 |
| Example | [μm] | [mg] | [per 100 mm²] | [per 100 mm²] |
| 1 | 15 | 50 | 9 | 9 |
| 2 | 15 | 30 | 15 | 15 |
| 3 | 15 | 2 | 121 | 121 |
| 4 | 11 | 30 | 45 | 45 |

### Comparative Examples 5 to 8 (Non-Inventive)

For Comparative Examples 5 to 8, the printing was effected according to the above point 3b) via the impression rolls of each printing unit, with the same voltage applied to each impression roll.

| | | | | Number |
|---|---|---|---|---|
| | | | Number | of missing |
| | Thickness of | | of missing | dots in |
| | outer | | dots in | each of |
| | polymer | Ignition | colour | colour |
| Comparative | layer | residue | application 1 | applications 2-6 |
| Example | [μm] | [mg] | [per 100 mm²] | [per 100 mm²] |
| 5 | 15 | 50 | 10 | 10 |
| 6 | 15 | 30 | 16 | 16 |
| 7 | 15 | 2 | 128 | 128 |
| 8 | 11 | 30 | 42 | 42 |

### Examples 1 to 4 (Inventive)

For Examples 1 to 4, the printing was effected according to the above point 3c) with charging by means of one electrode upstream of each print roll-impression roll pair, with the same voltage applied to all electrodes. No additional discharge electrodes were used here.

| | | | | Number |
|---|---|---|---|---|
| | | | Number | of missing |
| | Thickness of | | of missing | dots in |
| | outer | | dots in | each of |
| | polymer | Ignition | colour | colour |
| | layer | residue | application 1 | applications 2-6 |
| Examples | [μm] | [mg] | [per 100 mm²] | [per 100 mm²] |
| 1 | 15 | 50 | 0 | 6 |
| 2 | 15 | 30 | 0 | 15 |
| 3 | 15 | 2 | 7 | 32 |
| 4 | 11 | 30 | 7 | 32 |

### Examples 5 to 8 (Inventive)

For Examples 5 to 8, the printing was effected according to the above point 3d). The measurements in brackets were achieved after the results that are not in brackets were achieved. Between the measurements, the speed of the 6 printing units (and of the laminate movement) was increased by 50 m/min.

| | | | | Number |
|---|---|---|---|---|
| | | | Number | of missing |
| | Thickness of | | of missing | dots in |
| | outer | | dots in | each of |
| | polymer | Ignition | colour | colour |
| | layer | residue | application 1 | applications 2-6 |
| Examples | [μm] | [mg] | [per 100 mm²] | [per 100 mm²] |
| 5 | 15 | 50 | 0 (4) | 0 (4) |
| 6 | 15 | 30 | 0 (3) | 0 (3) |
| 7 | 15 | 2 | 7 (14) | 7 (14) |
| 8 | 11 | 30 | 6 (13) | 6 (13) |

### Examples 9 to 12 (Inventive)

For Examples 9 to 12, the printing was effected according to the above point 3e). The measurements in brackets were achieved after the results that are not in brackets were achieved. Between the measurements, the speed of the 6 printing units (and of the laminate movement) was increased by 50 m/min.

| | | | | Number |
|---|---|---|---|---|
| | | | Number | of missing |
| | Thickness of | | of missing | dots in |
| | outer | | dots in | each of |
| | polymer | Ignition | colour | colour |
| | layer | residue | application 1 | applications 2-6 |
| Examples | [μm] | [mg] | [per 100 mm²] | [per 100 mm²] |
| 9 | 15 | 50 | 0 (0) | 0 (0) |
| 10 | 15 | 30 | 0 (0) | 0 (0) |
| 11 | 15 | 2 | 2 (2) | 2 (2) |
| 12 | 11 | 30 | 2 (2) | 2 (2) |

The printing in the above examples and comparative examples for each printing unit was effected at 60 dots per cm. The layer thicknesses of the outer polymer layers reported in the above tables are each accurate to ±1.5 μm for measurement-related reasons.

Evaluation

Between Comparative Examples 1 to 4 on the one hand and Comparative Examples 5 to 8, no improvement was observed in the parameters adduced above within the scope of statistical deviations. In Examples 1 to 4, an improvement in the print was achieved. It is noticeable here, however, that the results for the second and every subsequent colour application are less good than for the first colour application. This disadvantage was remedied in Examples 5 to 8. A decoration with 6 colour applications of very good print quality is obtained here. In Examples 5 to 8, however, a change in speed of the printing units and hence in the laminate movement led to drops in the print quality. In Examples 9 to 12, by contrast, even after such a change in speed, a very good print quality of all colour applications is obtained. Such changes in speed are necessary in production, for example, after colour matching of the printing units and in the event of a change in decoration.

Moreover, the experiments have shown that it was possible to improve the ink drying after each printing unit, meaning that the colour printed on dried quicker after each printing unit with the same drying power. An improvement is found here in Examples 1 to 4 over Comparative Examples 1 to 8, but only for the first colour application. In Examples 5 to 12, such an improvement was achieved for all 6 colour applications. It is thus possible to conduct the laminate through the printing units at greater speed. This allows the time required for the printing of the laminate to be shortened. This increases the productivity of the laminate production and hence makes production less costly.

The figures show, in schematic form and not to scale, unless stated otherwise in the description or the respective figure:

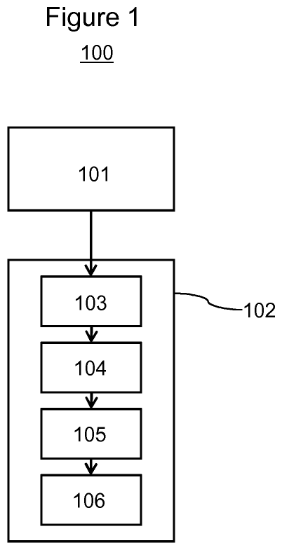

FIG. 1 a flow diagram of a method according to the invention;

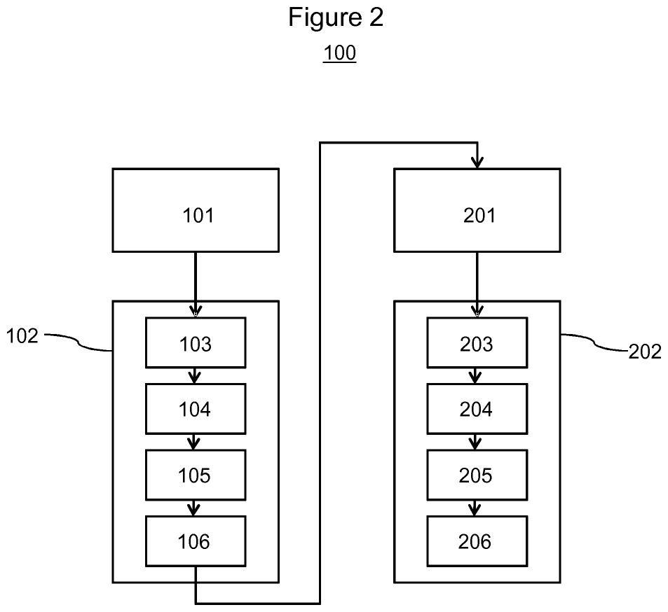

FIG. 2 a flow diagram of a further method according to the invention;

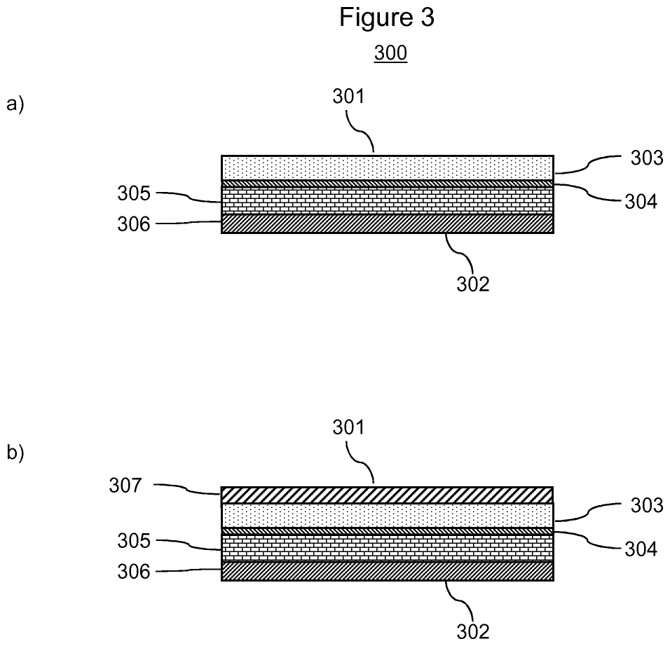

FIG. 3a) a schematic cross section through a sheetlike composite according to the invention;

FIG. 3b) a schematic cross section through a further sheetlike composite according to the invention;

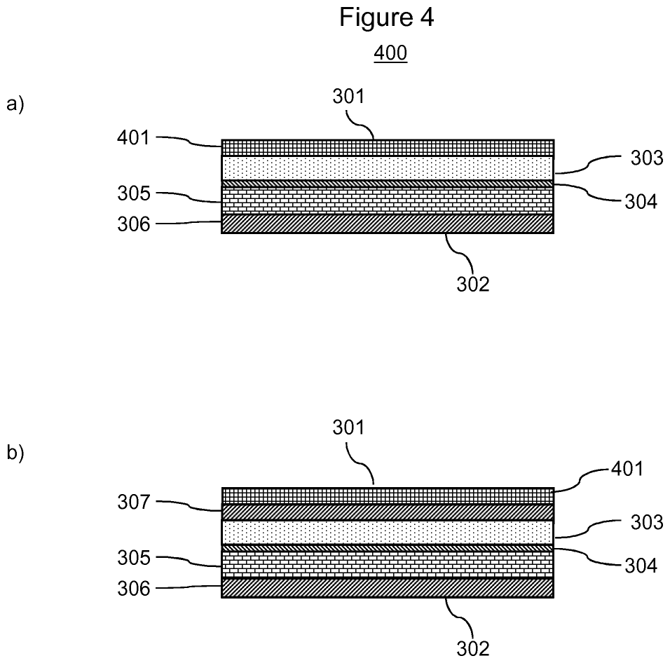

FIG. 4a) a schematic cross section through a printed sheetlike composite according to the invention;

FIG. 4b) a schematic cross section through a further printed sheetlike composite according to the invention;

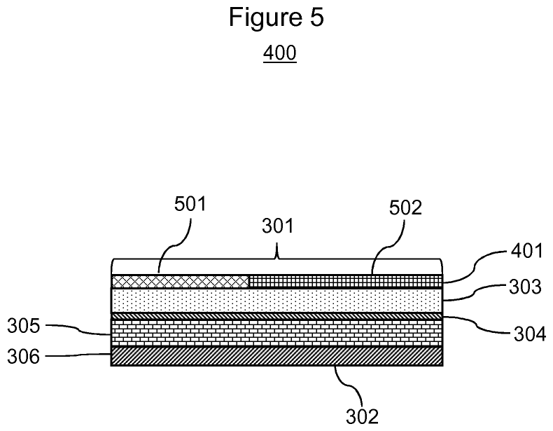

FIG. 5 a schematic cross section through a further printed sheetlike composite according to the invention;

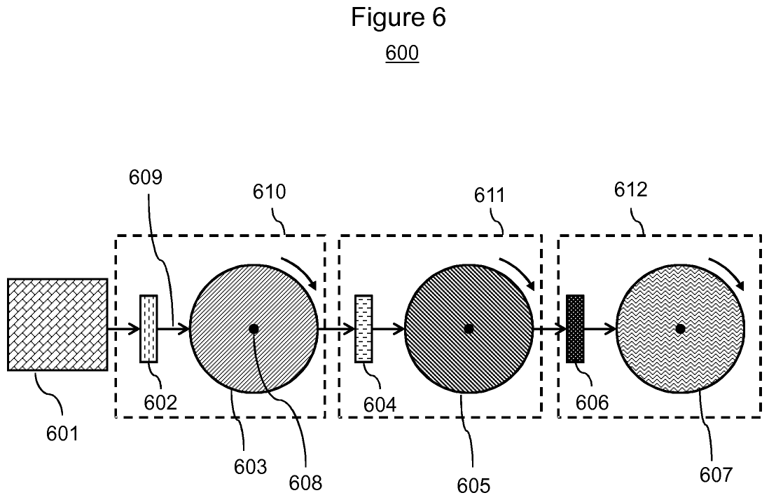

FIG. 6 a schematic diagram of an apparatus according to the invention;

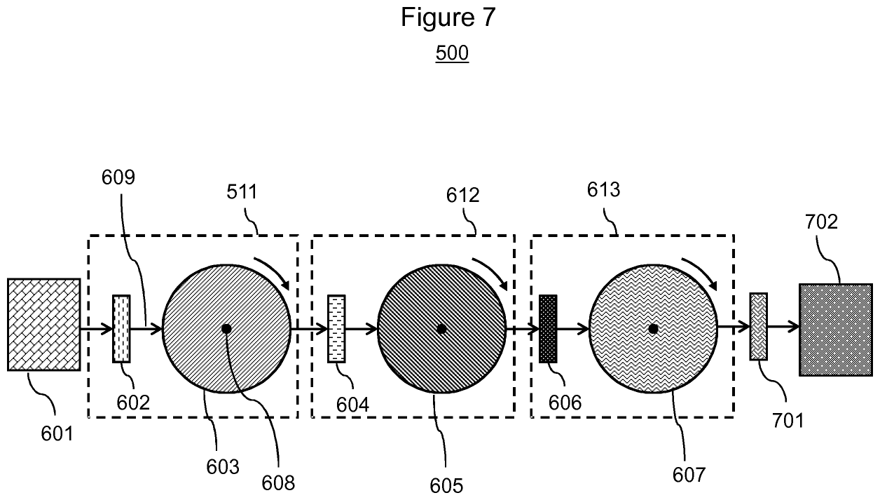

FIG. 7 a schematic diagram of a further apparatus according to the invention;

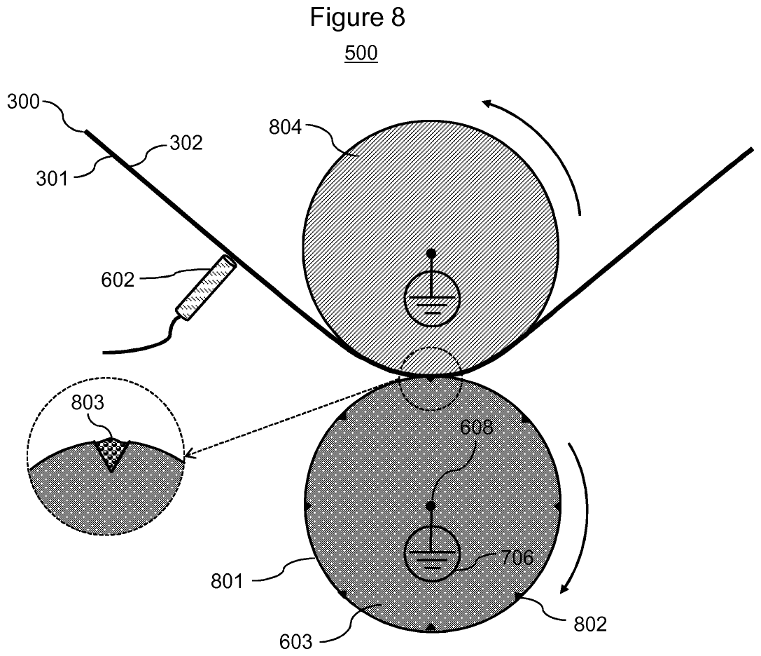

FIG. 8 a schematic detail from the apparatus according to FIG. 6;

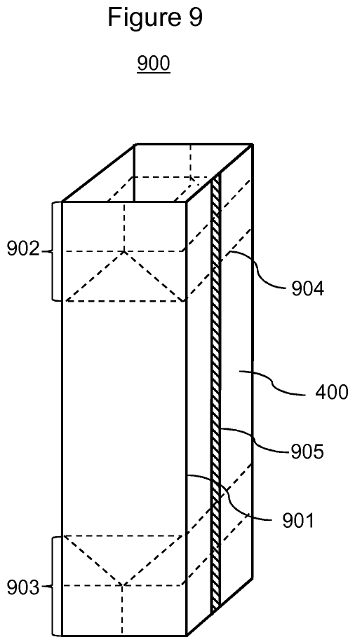

FIG. 9 a schematic view of a container precursor according to the invention;

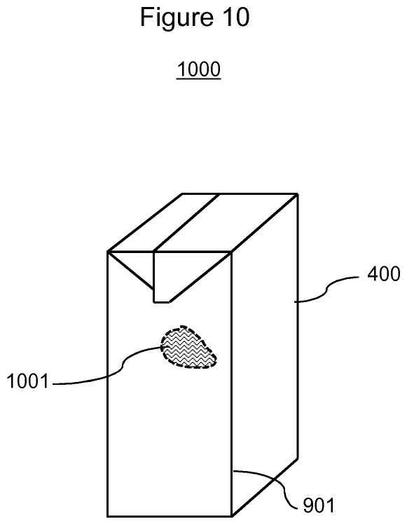

FIG. 10 a schematic view of a closed container according to the invention;

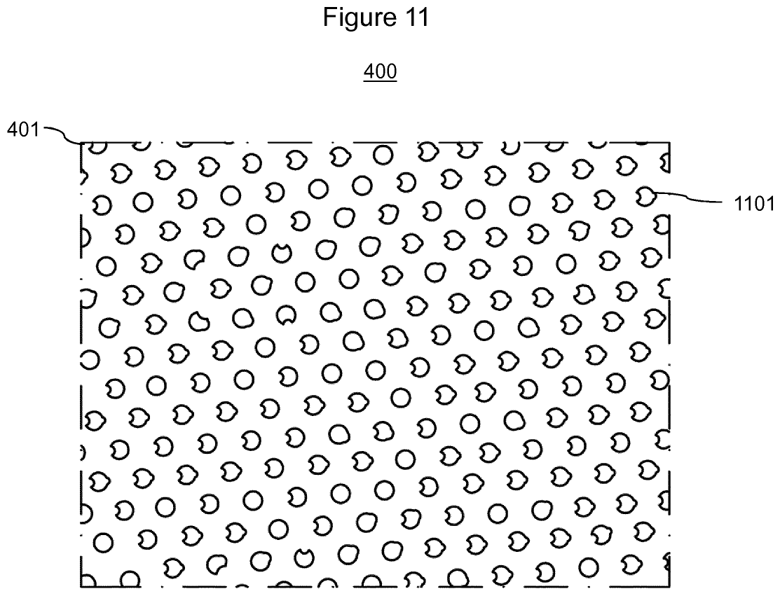

FIG. 11 a schematic detail of an enlarged top view of a printed sheetlike composite according to the invention;

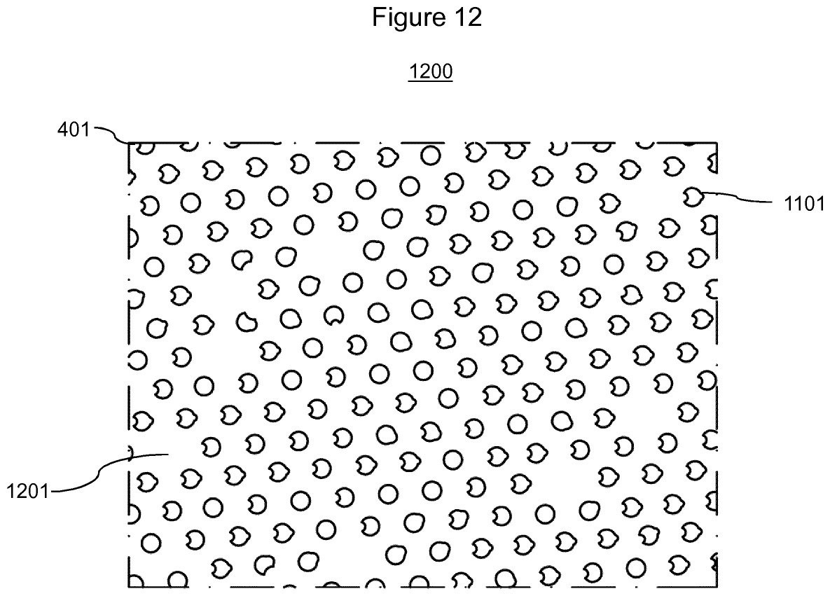

FIG. 12 a schematic detail of an enlarged top view of a printed sheetlike composite not according to the invention;

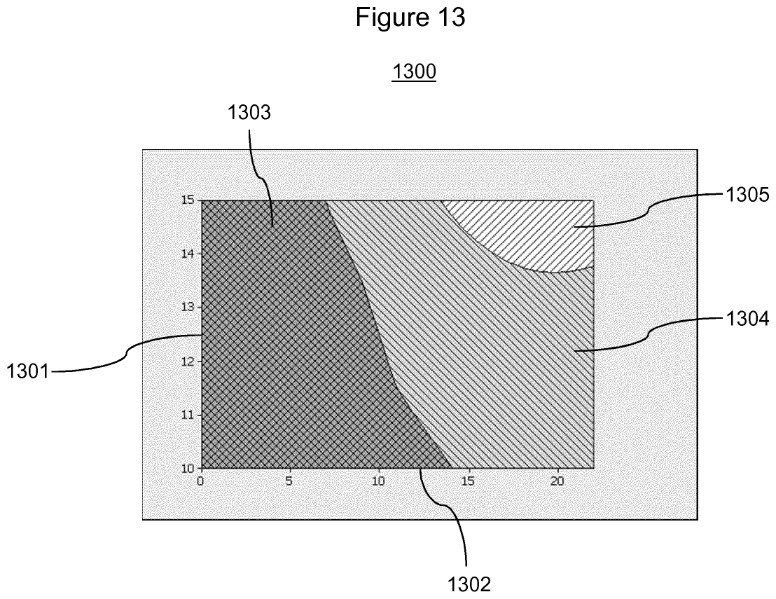

FIG. 13 a plot of the print quality by a method not according to the invention; and

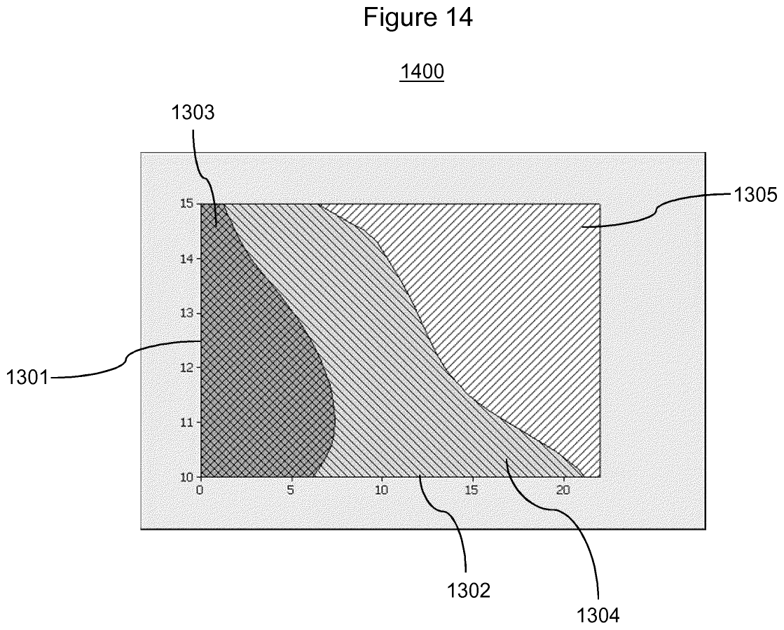

FIG. 14 a plot of the print quality by the method according to the invention.

FIG. 1 shows a flow diagram of a process 100 according to the invention. The process 100 comprises a process step a) 101: providing the sheetlike composite 300 according to FIGS. 3a) and 2 components, where the first component comprises a first component surface 801 and the second component a second component surface 801. In addition, the first and second component surfaces 801 each comprise a multitude of recesses 802, where the recesses 802 each comprise a composition 803 comprising a colourant. The 2 components each rotate in one method direction. The second component is arranged downstream of the first component in the method direction. In addition, the method 100 includes a method step b) 102: this comprises steps b) i) 103 and b) ii) 104 for the first component and b) i) 105 and b) ii) 106 for the second component. In method step b) 102, the sheetlike composite 300 is moved in such a way that a first region of the sheetlike composite 300 passes successively through steps b) i) 103, b) ii) 104, b) i) 105 and b) ii) 106. In step b) i) 103, a value of an electrical voltage between the first region and the first component surface 801 is increased. In this case, the voltage becomes more negative. In step b) ii) 104, the outer surface 301 of the sheetlike composite 300 is contacted with the first component surface 801 in the first region. In step b) i) 105, a value of an electrical voltage between the first region and the second component surface 801 is increased.

In this case, the voltage becomes more positive. In step b) ii) 106, the outer surface 301 of the sheetlike composite 300 is contacted with the second component surface 801 in the first region. According to the method 100, the sheetlike composite 300 can be printed with a two-colour decoration.

FIG. 2 shows a flow diagram of a further process 100 according to the invention. The process 100 of FIG. 2 is the process of FIG. 1, wherein, in FIG. 2, the sheetlike composite is moved at a composite speed in method step b) 102. Process step b) 102 is followed by a process step c) 201. In this step, the composite speed is increased by 150 m/min. In a further method step d) 202, the sheetlike composite 300 is moved at the elevated composite speed such that a further region of the sheetlike composite 300 passes successively through steps d) i) 203, d) ii) 204, d) i) 205 and d) ii) 206, which are included in method step d) 202. In step d) i) 203, a value of an electrical voltage between the further region and the first component surface 801 is increased. In this case, the voltage becomes more negative. In step d) ii) 204, the outer surface 301 of the sheetlike composite 300 is contacted with the first component surface 801 in the further region. In step d) i) 205, a value of an electrical voltage between the further region and the second component surface 801 is increased. In this case, the voltage becomes more positive. In step d) ii) 206, the outer surface 301 of the sheetlike composite 300 is contacted with the second component surface 801 in the further region. According to the method 100 of FIG. 2, the sheetlike composite 300 can be printed first with a two-colour decoration and then with another two-colour decoration.

FIG. 3a) shows a schematic cross section through a sheetlike composite 300 according to the invention. The sheetlike composite 300 consists of the following layers of a layer sequence in the direction from an outer face 301 of the sheetlike composite 300 to an inner face 302 of the sheetlike composite 300: a carrier layer 303 of paperboard; an intermediate polymer layer 304 as lamination layer, consisting of the LDPE 23L430 from Ineos GmbH, Cologne; a barrier layer 305 of aluminium; and an inner polymer layer 306.

FIG. 3b) shows a schematic cross section through a further sheetlike composite 300 according to the invention. The sheetlike composite 300 consists of the following layers of a layer sequence in the direction from an outer face 301 of the sheetlike composite 300 to an inner face 302 of the sheetlike composite 300: an outer polymer layer 307 of LDPE; a carrier layer 303 of paperboard; an intermediate polymer layer 304 as lamination layer, consisting of the LDPE 23L430 from Ineos GmbH, Cologne; a barrier layer 305 of aluminium; and an inner polymer layer 306.

FIG. 4a) shows a schematic cross section through a printed sheetlike composite 400 according to the invention. The printed sheetlike composite 400 consists of the following layers of a layer sequence in the direction from an outer face 301 of the printed sheetlike composite 400 to an inner face 302 of the printed sheetlike composite 400: a colour application 401; a carrier layer 303 of paperboard; an intermediate polymer layer 304 as lamination layer, consisting of the LDPE 23L430 from Ineos GmbH, Cologne; a barrier layer 305 of aluminium; and an inner polymer layer 306.

FIG. 4b) shows a schematic cross section through a further printed sheetlike composite 400 according to the invention. The printed sheetlike composite 400 consists of the following layers of a layer sequence in the direction from an outer face 301 of the printed sheetlike composite 400 to an inner face 302 of the printed sheetlike composite 400: a colour application 401; an outer polymer layer 307 of LDPE; a carrier layer 303 of paperboard; an intermediate polymer layer 304 as lamination layer, consisting of the LDPE 23L430 from Ineos GmbH, Cologne; a barrier layer 305 of aluminium; and an inner polymer layer 306.

FIG. 5 shows a schematic cross section through a further printed sheetlike composite 400 according to the invention. The printed sheetlike composite 400 according to FIG. 5 is the printed sheetlike composite 400 according to FIG. 4a), wherein the colour application 401 comprises a first colour application region 501 and a further colour application region 502, wherein the colour ink application region 501 is characterized by an area coverage of at least 80%, wherein the further colour application region 502 is characterized by an area coverage in a range of more than 10%, wherein the first colour application region 501 adjoins the further colour application region 502.

FIG. 6 shows a schematic diagram of an apparatus 600 according to the invention. The apparatus 600 comprises, as apparatus constituents: a feed device 601, wherein the feed device 601 is arranged and designed in order to roll up a sheetlike composite 300 according to FIG. 3a) and unroll it again; 3 components 603, 605, 607, wherein the first component 603 comprises a first component surface 801, the second component 605 a second component surface, and the third component 607 a third component surface. Each component surface comprises a multitude of recesses 802, cells. The cells are each designed to accommodate a composition 803 comprising a colourant. The composition 803 is a printing ink. The third component 607 is arranged downstream of the second component 605 in direction 609, and the latter downstream of the first component 603. In addition, the apparatus comprises 3 electrodes 602, 604, 606. The first electrode 602 is arranged here, in the downstream direction 609, before the first component 603, the second electrode 604 before the second component 605, and the third electrode 606 before the third component 607. In addition, the electrodes 602, 604, 606 are designed for exchange of electrical charge carriers with the outer surface 301 of the sheetlike composite 300. For this purpose, the electrodes 602, 604, 606 have graphite brushes. According to the terminology of the claims, in FIG. 6, n=3. Moreover, FIG. 6 shows a region 610 in which i=1, a region 611 in which i=2, and a region 612 in which i=3. The 3 components 603, 605, 607 are intaglio print rolls which each rotate about an axis 608 downstream in direction 609. The apparatus 600 can be used to print the sheetlike composite 300 with a three-colour decoration.

FIG. 7 shows a schematic diagram of a further apparatus 600 according to the invention. The apparatus 600 according to FIG. 7 is the apparatus 600 according to FIG. 6, wherein the apparatus according to FIG. 7 further comprises a fourth electrode 701 downstream of the third component 607 in direction 609. The fourth electrode 701 is designed to earth the sheetlike composite 300 on the outer surface 301. For this purpose, the fourth electrode 701 has a graphite brush. The apparatus 600 according to FIG. 7 further comprises a removal device 702 downstream of the third component 607 in direction 609. The removal device 702 is arranged and designed to accommodate the sheetlike composite 300.

FIG. 8 shows a schematic detail from the apparatus 600 according to FIG. 6. The detail shows the region 610 of FIG. 6 in more detail. The first component 603 can be seen, which rotates about the axis 608. The first component 603, which is an intaglio print roll, comprises the first component surface 801 with the multitude of recesses 802 which are cells. The cells each comprise the composition 803 which is a printing ink. In addition, FIG. 8 shows the first electrode 602 and the sheetlike composite 300 with its outer surface 301 and its inner surface 302. FIG. 8 further shows a first further component 804. This rotates in the opposite sense from the first component 801 about an axis 608. The first further component 804 is arranged and designed such that a region of the sheetlike composite 300 can be contacted on the outer surface 301 with the first component 603 and simultaneously on the inner surface 302 with the first further component 804. The first further component 804 is an impression roll. The impression roll 804 and the intaglio print roll 603 are earthed.

FIG. 9 shows a schematic view of a container precursor 900 according to the invention. The container precursor 900 shown here is a shell. The shell comprises a top region 902 and a base region 903. The top region 902 and the base region 903 each comprise grooves 904. By folding along the grooves 904 and sealing, it is possible to seal each of the top region 902 and the base region 903 and hence to obtain a closed container 1000 according to FIG. 10 from the shell. Accordingly, the container precursor 900 is a precursor of the closed container 1000 that arises in the container production process. In this context, the container precursor 900 comprises a blank of the sheetlike composite 400 according to FIG. 4b). In the container precursor 900, the sheetlike composite 400 has been folded; it comprises 4 folds 901 here. In addition, the shell comprises a longitudinal seam 905, along which the end regions of the sheetlike composite 400 are sealed to one another.

FIG. 10 shows a schematic view of a closed container 1000 according to the invention. The closed container 1000 is obtainable by folding the container precursor 900 in FIG. 9 along the grooves 904 and sealing folded regions to close the top region 902 and the base region 903. Accordingly, the closed container 1000 comprises a blank of the sheetlike composite 400 according to FIG. 4b). In addition, the closed container 1000 comprises at least 8 folds 901. The closed container 1000 surrounds an interior which comprises a food or drink product 1001. The food or drink product 1001 may be liquid, but may also comprise solid constituents. The closed container 1000 shown in FIG. 10 is in one-piece form. In addition, the closed container 1000 may be provided with a fitment to improve openability. This is the case especially when the carrier layer 303 of the sheetlike composite 400 has a hole.

FIG. 11 shows a schematic detail of an enlarged top view of a colour application 401 of a printed sheetlike composite 400 according to the invention. The colour application 401 was obtained by printing with the apparatus 600 according to FIG. 6 and consists of printed dots 1101. The printed sheetlike composite 400 consists of the following layers, mutually superposed in this sequence, from an outer surface 301 of the printed sheetlike composite 400 to an inner surface 302 of the printed sheetlike composite 400: the colour application 401; an outer polymer layer 307 of LDPE Novex® M19N430 from Ineos Köln GmbH; a single paper coating obtainable by coating with a liquid formulation comprising 100 parts pigment (Hydrocarb 60; Omya Inc; Cincinnati, US) and 20 parts binder/SB latex (MAINCOTE™ HG-56; Dow; Germany); a carrier layer 303 of NaturaD UC 200 mN, Stora Enso AB, Stockholm, Sweden; an LDPE layer 204 of LDPE Novex® M19N430 from Ineos Köln GmbH; a barrier layer 305 of Aluminium EN A W 8079 from Hydro Aluminium Deutschland GmbH having a layer thickness of 6 μm; and an inner polymer layer 306 of a PE blend, comprising an mLDPE to an extent of 30% by weight and an LDPE to an extent of 70% by weight, based in each case on the total weight of the inner polymer layer 306, having a weight per unit area of 22 g/m². The colour application 401 consists of a print obtained by intaglio printing, characterized by a pattern having 60 dots per cm and an area coverage of 30%.

FIG. 12 shows a schematic detail of an enlarged top view of a print on a printed laminate 1200 not according to the invention. The print was obtained by intaglio printing without electrostatic assistance according to the invention. Thus, the print was not obtained by the method 100 according to the invention. The print consists of printed dots 1101. The laminate 1200 consists of the following layers, mutually superposed in this sequence: the print; an outer polymer layer of LDPE Novex® M19N430 from Ineos Köln GmbH; a single paper coating obtainable by coating with a liquid formulation comprising 100 parts pigment (Hydrocarb 60; Omya Inc; Cincinnati, US) and 20 parts binder/SB latex (MAINCOTE™ HG-56; Dow; Germany); a carrier layer 203 of NaturaD UC 200mN, Stora Enso AB, Stockholm, Sweden; an LDPE layer 204 of LDPE Novex® M19N430 from Ineos Köln GmbH; a barrier layer of Aluminium EN A W 8079 from Hydro Aluminium Deutschland GmbH having a layer thickness of 6 μm; and an inner polymer layer of a PE blend, comprising an mLDPE to an extent of 30% by weight and an LDPE to an extent of 70% by weight, based in each case on the total weight of the inner polymer layer 208, having a weight per unit area of 22 g/m². The print is characterized by a pattern having 60 dots per cm and an area coverage of 30%. The print shown is characterized by a much higher number of missing dots compared to the printed sheetlike composite 400 according to the invention from FIG. 11.

FIG. 13 shows a plot 1300 of the print quality by a method not according to the invention. Printing was effected here, without electrostatic assistance according to the invention, onto various laminates consisting of the following layers of a layer sequence: an outer polymer layer of LDPE; a carrier layer of paperboard; an intermediate polymer layer as lamination layer consisting of the LDPE 23L430 from Ineos GmbH, Cologne; a barrier layer of aluminium; and an inner polymer layer. This involved successively printing 6 colour applications of different colours. Thus, a multicoloured decoration was obtained. The ordinate axis 1301 shows a weight per unit area of the outer polymer layer in g/m². The abscissa axis 1302 shows a weight per unit area of a cover layer of the carrier layer that faces the outer polymer layer in g/m². The decorations having print qualities that are shown in the plot 1300 were each printed with a pattern of 60 dots 1101 per cm and an area coverage of 90%. In the plot 1300, the region 1305 has fewer than 3 missing dots 1201 per 100 mm² for each colour application, the region 1304 has 3 to 10 missing dots 1201 per 100 mm² for each colour application, and the region 1303 has more than 10 missing dots 1201 per 100 mm² for each colour application.

FIG. 14 shows a plot 1400 of the print quality by the method 100 according to the invention. Printing was effected here by the method 100 according to the invention onto various sheetlike composites 300 consisting of the following layers of a layer sequence: an outer polymer layer 307 of LDPE; a carrier layer 303 of paperboard; an intermediate polymer layer 304 as lamination layer consisting of the LDPE 23L430 from Ineos GmbH, Cologne; a barrier layer 305 of aluminium; and an inner polymer layer 306. This involved successively printing 6colour applications 401 of different colours. Thus, a multicoloured decoration was obtained. The ordinate axis 1301 shows a weight per unit area of the outer polymer layer 307 in g/m². The abscissa axis 1302 shows a weight per unit area of a cover layer of the carrier layer 303 that faces the outer polymer layer 307 in g/m². The decorations having print qualities that are shown in the plot 1400 were each printed with a pattern of 60 dots 1101 per cm and an area coverage of 90%. In the plot 1400, the region 1305 has fewer than 3 missing dots 1201 per 100 mm² for each colour application 401, the region 1304 has 3 to 10 missing dots 1201 per 100 mm² for each colour application 401, and the region 1303 has more than 10 missing dots 1201 per 100 mm² for each colour application 401. It is clearly apparent that an improved print quality has been achieved compared to FIG. 13.

### LIST OF REFERENCE SYMBOLS

100 method according to the invention

101 method step a)

102 method step b)

103 step b) i) for i=1

104 step b) ii) for i=1

105 step b) i) for i=2

106 step b) ii) for i=2

201 method step c)

202 method step d)

203 step d) i) for i=1

204 step d) ii) for i=1

205 step d) i) for i=2

206 step d) ii) for i=2

300 sheetlike composite

301 outer surface

302 inner surface

303 carrier layer

304 intermediate polymer layer

305 barrier layer

306 inner polymer layer

307 outer polymer layer

400 printed sheetlike composite according to the invention

401 colour application

501 first colour application region

502 further colour application region

600 apparatus of the invention

601 feed device

602 first electrode

603 first component

604 second electrode

605 second component

606 third electrode

607 third component

608 axis

609 downstream direction

610 i=1

611 i=2

612 i=3

701 fourth electrode

702 removal device

801 component surface

802 recess

803 composition

804 further component

900 container precursor of the invention

901 fold

902 top region

903 base region

904 groove

905 longitudinal seam

1000 closed container of the invention

1001 food or drink product

1101 dot

1200 printed laminate not according to the invention

1201 missing dot

1300 plot of the print quality by a method not according to the invention

1301 weight per unit area of the outer polymer layer in g/m²

1302 weight per unit area of the cover layer of the carrier layer in g/m²

1303 print quality still acceptable

1304 good print quality

1305 excellent print quality

1400 plot of the print quality by the method according to the invention

1. A method comprising, as method steps,
a) providing
i) a sheetlike composite comprising, as mutually superposed layers, from an outer surface of the sheetlike composite to an inner surface of the sheetlike composite,
A) a carrier layer,
B) a barrier layer, and
C) an inner polymer layer,
ii) n components where, for every i from 1 to n,
A) the ith component comprises an ith component surface, and
B) the ith component surface comprises a multitude of recesses, wherein the recesses each comprise a composition comprising a colourant,
wherein the n components rotate in one method direction,
wherein, for every i from 1 to (n−1), the (i+1)th component is arranged after the ith component in the method direction; and
b) moving the sheetlike composite, such that a first region of the sheetlike composite runs through the following sequence of steps comprising steps b) i) and b) ii) successively for every i from 1 to n in ascending sequence:
i) altering an electrical voltage between the first region and the ith component surface, and
ii) contacting the outer surface of the sheetlike composite in the first region with the ith component surface;
where n is a natural number and is at least 2,
where i is a natural number.

2. The method according to claim 1, wherein, for every i from 1 to n in method step b) i), the altering of the electrical voltage between the first region and the ith component surface is an increase in the absolute value of the electrical voltage.

3. The method according to claim 2, wherein, for every i from 1 to n in method step b) i), the increase in the absolute value of the electrical voltage is to an absolute value in a range from 200 to 1500 V.

4. The method according to claim 1, wherein, for every odd i, the altering of the electrical voltage in method step b) i) is in the opposite sense to the altering of the electrical voltage for every even i in method step b) i).

5. The method according to claim 1, wherein, in method step a), n electrodes are further provided;
wherein, for every i from 1 to n,
a. the ith electrode is arranged and designed for exchange of electrical charge carriers with the outer surface of the sheetlike composite, and
b. the ith electrode is arranged before the ith component looking downstream;
wherein, for every i, in method step b) i), an ith charge voltage is applied to the ith electrode,
wherein an absolute value of the ith charge voltage for every odd i is different by less than 500 V from an absolute value of the ith charge voltage for every even i.

6. A printed sheetlike composite obtainable by the method according to claim 1.

7. An apparatus comprising, as apparatus constituents:
a) a feed device, wherein the feed device is arranged and designed to accommodate a sheetlike composite comprising, as mutually superposed layers, from an outer surface of the sheetlike composite to an inner surface of the sheetlike composite,
i) a carrier layer,
ii) a barrier layer, and
iii) an inner polymer layer;
b) n components, where, for every i from 1 to n,
i) the ith component comprises an ith component surface, and
ii) the ith component surface comprises a multitude of recesses, wherein the recesses are each designed to accommodate a composition comprising a colourant,
wherein the n components are arranged after the feed device looking downstream,
wherein, for every i from 1 to (n−1), the (i+1)th component is arranged after the ith component looking downstream; and
c) n electrodes, where, for every i from 1 to n, the ith electrode
i) is arranged and designed for exchange of electrical charge carriers with the outer surface of the sheetlike composite,
ii) is arranged before the ith component looking downstream;
where n is a natural number and is at least 2,
where i is a natural number.

8. A printed sheetlike composite comprising, as mutually superposed layers, from an outer surface of the printed sheetlike composite to an inner surface of the printed sheetlike composite,
i) a colour application,
ii) a carrier layer,
iii) a barrier layer, and
iv) an inner polymer layer,
wherein the printed sheetlike composite is characterized by an ignition residue determined by the method described herein in a range from 0.1 to 75 mg.

9. The printed sheetlike composite according to claim 8, wherein the colour application is characterized by a number of missing dots in a range from 0 to 100 per 100 mm².

10. The printed sheetlike composite according to claim 8, wherein the carrier layer is overlaid by m further colour applications on a side of the carrier layer remote from the barrier layer,
wherein the colour application and the m further colour applications each comprise a different colourant,
wherein each of the m further colour applications is characterized by a number of missing dots in a range from 0 to 100 per 100 mm²,
where m is a natural number and is at least 1.

11. A printed sheetlike composite comprising, as mutually superposed layers, from an outer surface of the printed sheetlike composite to an inner surface of the printed sheetlike composite,
i) a colour application,
ii) an outer polymer layer,
iii) a carrier layer),
iv) a barrier layer, and
v) an inner polymer layer,
wherein the outer polymer layer is characterized by a layer thickness in a range from 1 to 30 μm.

12. The printed sheetlike composite according to claim 11, wherein the outer polymer layer is overlaid by m further i colour applications on a side of the outer polymer layer remote from the carrier layer,
wherein the colour application and the m further colour applications each comprise a different colourant,
where m is a natural number and is at least 1.

13. A container precursor at least partly comprising the printed sheetlike composite according to any claim 6.

14. A closed container at least partly comprising the printed sheetlike composite according to claim 6,
wherein the printed sheetlike composite has been folded at least once.

15. A use of the apparatus according to claim 7 for printing of the sheetlike composite.
